(19) United States
(12) Patent Application Publication
(10) Pub. No.: US 2015/0254106 A1
(43) Pub. Date: Sep. 10, 2015

(54) NON-TRANSITORY COMPUTER-READABLE RECORDING MEDIUM RECORDING PROCESSING PROGRAM, PROCESSING APPARATUS, AND PROCESSING METHOD

(71) Applicant: FUJITSU LIMITED, Kawasaki-shi (JP)

(72) Inventors: Nobuko Takase, Mizuho (JP); Takashi Satoh, Kasugai (JP); Ikuko Hosokawa, Nagoya (JP); Hiroyuki Yamaguchi, Toyota (JP); Kunihiro Adachi, Hashima (JP); Yoshiyuki Torii, Anjo (JP); Tomoko Tanaka, Nagoya (JP); Kiyoshi Kouge, Kuwana (JP)

(21) Appl. No.: 14/617,390

(22) Filed: Feb. 9, 2015

(30) Foreign Application Priority Data
Mar. 7, 2014 (JP) 2014-045352

(51) Int. Cl. G06F 9/48

(52) U.S. Cl. CPC G06F 9/4887

(57) ABSTRACT

The present processing apparatus includes an extraction unit and a control unit. The extraction unit extracts a job group including an extraction job and a subsequent job from a plurality of scheduled jobs, the plurality of scheduled jobs being included in a second operation, the second operation being scheduled in a second period which is after a first period in which a first operation is scheduled, the extraction job extracting a data group and being included in the plurality of scheduled jobs, and the subsequent job processing on the data group within a range of the data group. The control unit executes jobs in the extracted job group in the first period. Accordingly, the second operation can be completed by the start of the first operation.

### CROSS-REFERENCE TO RELATED APPLICATION

This application is based upon and claims the benefit of priority of the prior Japanese Application No. 2014-045352 filed on Mar. 7, 2014 in Japan, the entire contents of which are hereby incorporated by reference.

### FIELD

The present invention relates to a non-transitory computer-readable recording medium recording a processing program, a processing apparatus, and a processing method.

### BACKGROUND

In a business operation system, an online operation and a batch operation are performed. Data used for performing a batch operation is ready when all online operation in the online operation is completed. Thus, performing the batch operation collectively after the online operation is completed and the data is ready is considered to be efficient.

Therefore, in a period before the start (deadline) of the next online operation after the online operation terminates, the following ingenious ways have been devised to terminate the batch operation without delay. That is, resources for batch operation are increased or the batch operation is processed in parallel and both are ingenious ways within the execution time of the batch operation.

In batch operations in recent years, information system processing other than basic task processing has increased. Because the amount of data handled by information system processing is larger by an order of magnitude, “jobs whose execution time is long” in recent years have become longer by an order of magnitude. The basic task processing is, for example, processing to order items running out of stock based on data of store sales such as POS (Point Of Sales) data. The information system processing is, for example, processing that predicts hit products by analyzing a large amount of information of various kinds, for example, sales change information from the POS data and word-of-mouth information such as Twitter and blogs.

There are some cases in which the batch operation is delayed due to an increase of the amount of input data “beyond expectation” caused by a deluge of money transfer processing or the like and ATM (Automated Teller Machine) is stopped. Particularly, systems called social systems are desired to take countermeasures against such an abrupt increase of the amount of data “beyond expectation”.

On the other hand, due to longer business hours to improve services, online operations become longer, leading to a shorter time in which batch operations can be performed.

In circumstances in which, as described above, the execution time of the online operation (first operation) becomes longer and the execution time of the batch operation (second operation) becomes shorter and also the amount of data could abruptly increase beyond expectation, it is difficult to inhibit any delay of batch operation to inhibit deadline passing only by devising ingenious ways within the execution time of batch operation.

### SUMMARY

A processing program in the present application causes a computer to perform processing below: Processing to extract a job group including an extraction job and a subsequent job from a plurality of scheduled jobs, the plurality of scheduled jobs being included in a second operation, the second operation being scheduled in a second period which is after a first period in which a first operation is scheduled, the extraction job extracting a data group and being included in the plurality of scheduled jobs, and the subsequent job processing on the data group within a range of the data group. Processing to execute jobs in the extracted job group in the first period.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1A is a diagram illustrating an overview of a processing method of a batch operation according to existing technology;

FIG. 1B is a diagram illustrating the overview of the processing method of the batch operation according to the present embodiment;

FIG. 2 is a diagram illustrating technical problems of the batch operation according to the present embodiment;

FIG. 3A is a diagram illustrating the overview of the processing method of the batch operation according to the existing technology;

FIG. 3B is diagram illustrating the overview of the processing method of the batch operation according to the present embodiment;

FIG. 4 is a diagram showing the configuration of nighttime batch operation;

FIG. 5 is a diagram showing the configuration of the nighttime batch operation in more detail to illustrate an extraction job;

FIGS. 6 and 7 are diagrams illustrating the nighttime batch operation that can independently be executed after being divided;

FIG. 8 is a diagram illustrating cooperation processing;

FIG. 9 is a diagram illustrating a checking method of a job (application) including insertion processing, update processing, or deletion processing of data from a database;

FIG. 10A is a diagram illustrating Pattern 1 of the range of jobs to be moved forward;

FIG. 10B is a diagram illustrating Pattern 2 of the range of jobs to be moved forward;

FIG. 11 is a diagram illustrating the range of processing that can be moved forward concerning Pattern 2 in FIG. 10B;

FIG. 12 is a diagram showing a configuration example a nighttime batch (job net) intended for creating a table listing forward movable jobs;

FIG. 13 is a diagram showing an example of the table listing forward movable jobs according to the present embodiment;

FIG. 14 is a diagram showing an example (initial state) of a database access job net management information table according to the present embodiment;

FIG. 15 is a diagram showing an example (initial state) of a database transaction information table according to the present embodiment;

FIG. 16 is a diagram showing an example of the database access job net management information table in which the execution time (normal) of each job collected in a test processing is recorded;

FIG. 17 is a diagram showing an example of the database transaction information table in which the transaction amount (normal) with each database collected in the test processing is recorded;

FIG. 18 is a diagram showing an example of the database transaction information table in which the transaction amount (track record) with each database collected in an actual processing is recorded;

FIG. 19 is a diagram showing an example of the database access job net management information table in which the execution time (predicted) when there is no increase of the transaction amount during actual processing is recorded;

FIG. 20 is a diagram showing an example of the database access job net management information table in which the execution time (predicted) when there is an increase of the transaction amount during actual processing is recorded;

FIG. 21 is a diagram showing an example of a table listing candidates to be moved forward according to the present embodiment;

FIG. 22 is a diagram showing an example of a table listing job groups to be moved forward according to the present embodiment;

FIG. 23 is a diagram extracting and showing principal portions from the table listing forward movable jobs shown in FIG. 13;

FIG. 24 is a diagram illustrating forwarded processing according to the present embodiment;

FIG. 25 is a diagram illustrating an example of batch operation when the forwarded processing is performed only once;

FIG. 26 is a diagram illustrating an example of the batch operation when the forwarded processing is performed twice or more;

FIG. 27 is a block diagram showing a hardware configuration example and a function configuration example of a job management server (processing apparatus) according to the present embodiment;

FIG. 28 is a block diagram showing a function configuration example of a scheduling apparatus according to the present embodiment;

FIG. 29 is a flow chart illustrating an operation overview during job execution by the scheduling apparatus shown in FIG. 28;

FIG. 30 is a flow chart illustrating a test operation setting operation in the scheduling apparatus shown in FIG. 28;

FIG. 31 is a flow chart illustrating a deadline time setting operation in the scheduling apparatus shown in FIG. 28;

FIGS. 32 to 37 are flow charts illustrating an operation of a forward moving job extraction unit in the scheduling apparatus shown in FIG. 28;

FIGS. 38 to 40 are flow charts illustrating the operation of a database access setting unit in the scheduling apparatus shown in FIG. 28;

FIGS. 41 and 42 are flow charts illustrating the operation of a database access analysis unit in the scheduling apparatus shown in FIG. 28;

FIGS. 43 to 45 are flow charts illustrating the operation of a forward moving job determination unit in the scheduling apparatus shown in FIG. 28;

FIG. 46 is a flow chart illustrating the operation of an input data management unit in the scheduling apparatus shown in FIG. 28;

FIGS. 47 and 48 are flow charts illustrating the operation of a job execution unit in the scheduling apparatus shown in FIG. 28;

FIG. 49 is a flow chart illustrating the operation of an output data management unit in the scheduling apparatus shown in FIG. 28;

FIG. 50 is a diagram showing an example of system definition information according to the present embodiment;

FIG. 51 is a diagram showing an example of job net definition information according to the present embodiment; and

FIG. 52 is a diagram showing an example of a critical path management information table according to the present embodiment.

### DESCRIPTION OF THE PREFERRED EMBODIMENTS

Hereinafter, embodiments of a non-transitory computer-readable recording medium recording a processing program, a processing apparatus, and a processing method disclosed by the present application will be described in detail with reference to the drawings. However, the embodiments shown below are only by way of example and there is no intention of excluding various modifications and technical applications that are not explicitly described in the embodiments. That is, the present embodiment can be modified in various ways without deviating from the spirit thereof. Each drawing is not intended to include only elements in the drawing and can contain other functions. In addition, each embodiment can appropriately be combined within a range causing no conflict of processing content.

### [1] Processing Method of a Batch Operation in the Present Embodiment

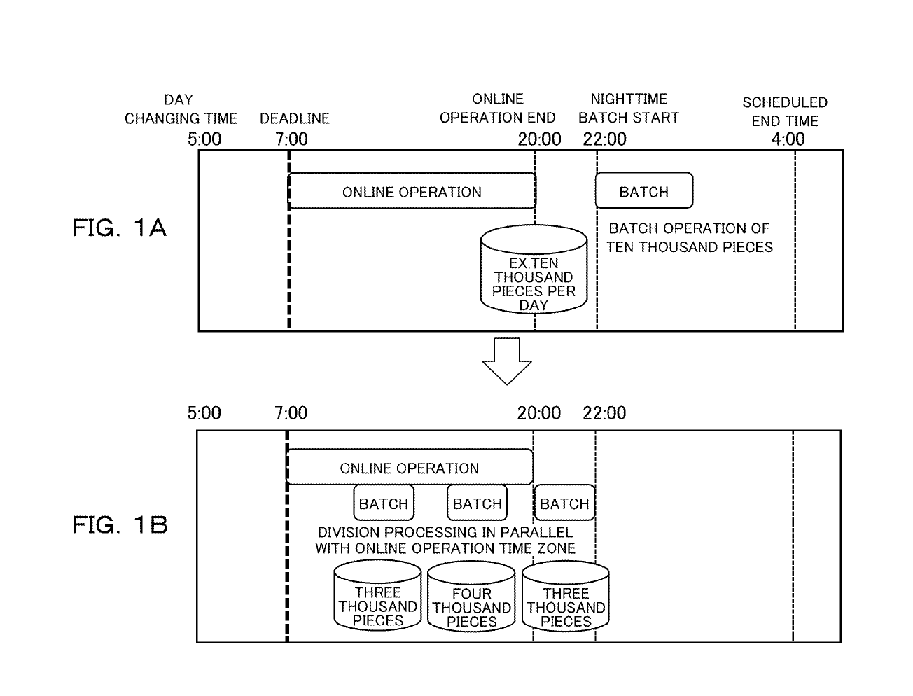

The processing method of a batch operation in the present embodiment will be described with reference to FIGS. 1A to 26.

In circumstances in which, as described above, the execution time of the online operation becomes longer and the execution time zone of the batch operation becomes shorter and also the amount of data could abruptly increase beyond expectation, it is difficult to inhibit any delay of batch operation only by devising ingenious ways within the execution time zone of batch operation. Thus, the processing method in the present embodiment efficiently enables execution of a batch operation by, as shown in FIGS. 1A and 1B, going back to before the start time of the batch operation, that is, a time zone of the online operation to inhibit deadline passing by inhibiting any delay of the batch operation.

FIG. 1A is a diagram illustrating an overview of a processing method of a batch operation according to existing technology and FIG. 1B is a diagram illustrating the overview of the processing method of the batch operation according to the present embodiment. In FIGS. 1A and 1B, a day changing time is a time of the start of operation (start time of a day in the operation unit) and a deadline is a time by which the batch operation needs to be finished (start time of the online operation). Further, a scheduled end time is a desired time to terminate an operation (job net) preset by an operator for delay monitoring.

In the processing method of the batch operation according to the existing technology, as shown in FIG. 1A, online operation is performed, for example, between the deadline time 7:00 and the online operation end time 20:00. Accordingly, an online operation result for one day, for example, ten thousand pieces are obtained. Then, batch operation on the online operation result for one day (ten thousand pieces) is performed starting at, for example, the nighttime batch start time 22:00.

In contrast, in the processing method of the batch operation according to the present embodiment, as shown in FIG. 1B, a portion of the batch operation is divided and executed in a time zone of the online operation in parallel with the online operation. That is, in the example shown in FIG. 1B, batch operation on an online operation result of first three thousand pieces is performed in parallel with the online operation and then, batch operation on an online operation result of the next four thousand pieces is performed in parallel with the online operation. Then, batch operation on an online operation result of the last three thousand pieces is performed in a time zone between the end of the online operation and the start of the nighttime batch.

To realize processing as shown in FIG. 1B, a batch job (application registered as a batch job) to be originally processed collectively after the online operation is finished will be operated in a time zone of the online operation. Thus, it is necessary to consider the fact that the application will be executed in a state in which a plurality of pieces of online operation is not completed and all data (all online operation results) for one day is not ready.

### [1-1] Prerequisites and Technical Problems

### [1-1-1] Prerequisites

Nighttime batch operation roughly includes the following two jobs (applications) A1, A2. In the description that follows, a “data segment” is an example a “data group”.

A1: Batch data processing that performs one piece of processing on one data segment (for example, processing to create one sales slip for one sales input)

A2: Batch data processing that performs processing such as analysis and tabulation on all data segments for one day (unified time unit meaningful as an operation) (for example, processing on data of store sales for one day to analyze or tabulate sales trends based on the item, region, time zone, gender, age and so on)

Batch operation that can be performed in parallel in a time zone of the online operation is an application of the type corresponding to the above item A1 and an application of the type corresponding to the above item A2 cannot be performed in parallel in a time zone of the online operation. Therefore, a batch application should be moved forward and executed in a time zone of the online operation, it is necessary to identify an application of the type corresponding to the above item A1 in advance.

### [1-1-2] Technical Problem I (Identifying the Type Corresponding to the Above Item A1 and Also Identifying the forward movable job range without modifying an application)

To identify an application of the type corresponding to the above item A1, modifying an application after analyzing content of applications as resources of the operator (client) can be considered. However, in a batch operation system in which tens of thousands to hundreds of thousands of batch jobs (applications) are registered, enormous amounts of cost are needed to analyze content of various kinds of processing of the applications by hand (using manpower) and then to correctly identify and maintain the type of the item A1. More realistically, it is impossible to sustain the maintenance. Therefore, it is difficult to modify the applications so as to be caused to output information for forward moved processing and the information is not obtained from the applications side.

When jobs that can be moved forward are extracted by conducting data analysis, it is desired to determine the range of jobs that can be moved forward. For this purpose, not only the flow of prior/subsequent relationships of jobs, but also the flow of operations (batch operation itself) in which subsequent operation waits via data update to a business database (DB) or file creation/file transfer needs to be considered. In the whole batch operation in which various kinds of data are exchanged, however, it is difficult to identify the range of jobs that can be moved forward by tracking each flow of data.

### [1-1-3] Technical Problem II (Inhibiting an Occurrence of Double Processing or Omission of Data Even if a Portion of Batch Operation is Divided and Performed)

Processing a portion of batch operation in parallel in a time zone of the online operation means processing batch operation performed in the nighttime collectively in the past several times by dividing the batch operation.

In the above technical problem I, even if an application of the type corresponding to the above item A1 is identified and the range of jobs (job groups) that can be moved forward is identified, the application developed for nighttime batch operation normally performs batch operation by assuming a state in which all data segments are ready.

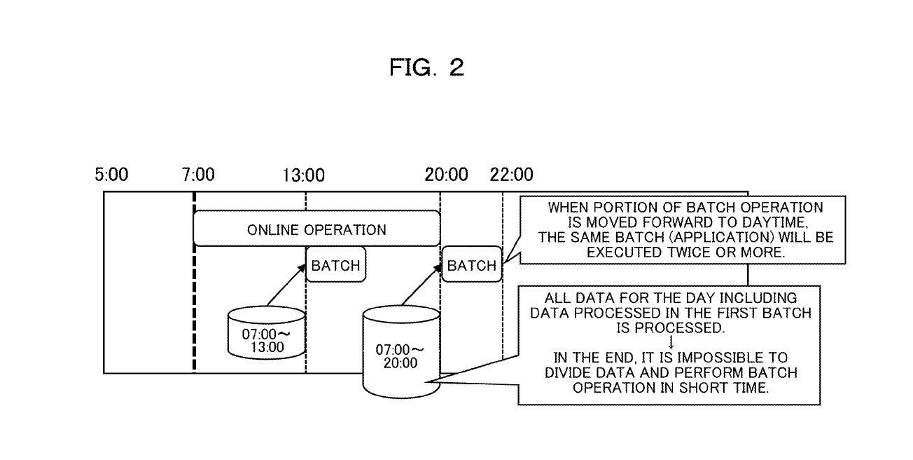

Thus, if a portion of batch operation is simply divided and performed by moving forward, batch operation is performed on all data accumulated in the timing and division and execution. Thus, as shown in FIG. 2, double processing of data occurs and in the end, the execution time of the last batch operation after the online operation is finished is not shortened.

FIG. 2 is a diagram illustrating technical problems of batch operation in the present embodiment. In the example shown in FIG. 2, after batch operation of data segments accumulated in the time 7:00 to 13:00 is started at 13:00, batch operation of data segments accumulated in the time 7:00 to 20:00 is started at 20:00. That is, in the batch operation started at 20:00, all data segments including data segments processed in the first operation will be processed. Thus, even if a portion of batch operation is moved forward to the daytime, the same batch (application) will be executed twice or more. Therefore, even if data is divided, batch operation cannot be performed in a short time.

To reduce the execution time of batch operation, it is necessary to exercise control to avoid double processing of processed data by being moved forward and processed and also to exercise control such that the final output produces the same result as when the nighttime batch is executed at a time. However, various types of processing exist as relevant applications (batch jobs) and input/output data is processed in various ways and therefore, it is difficult to control all applications in the way as described above.

### [1-2] Solution to Technical Problems

In the processing method of batch operations in the present embodiment, a job group that can be moved forward is extracted from batch operation (nighttime batch; second operation) after a plurality of pieces of predetermined operation (online operation; first operation) is completed. Then, if an abrupt increase of data is predicted in the online operation, the extracted job group is executed in parallel with the plurality of pieces of predetermined operation (online operation). Accordingly, batch operation on data segments processed online is moved forward and performed to inhibit deadline passing.

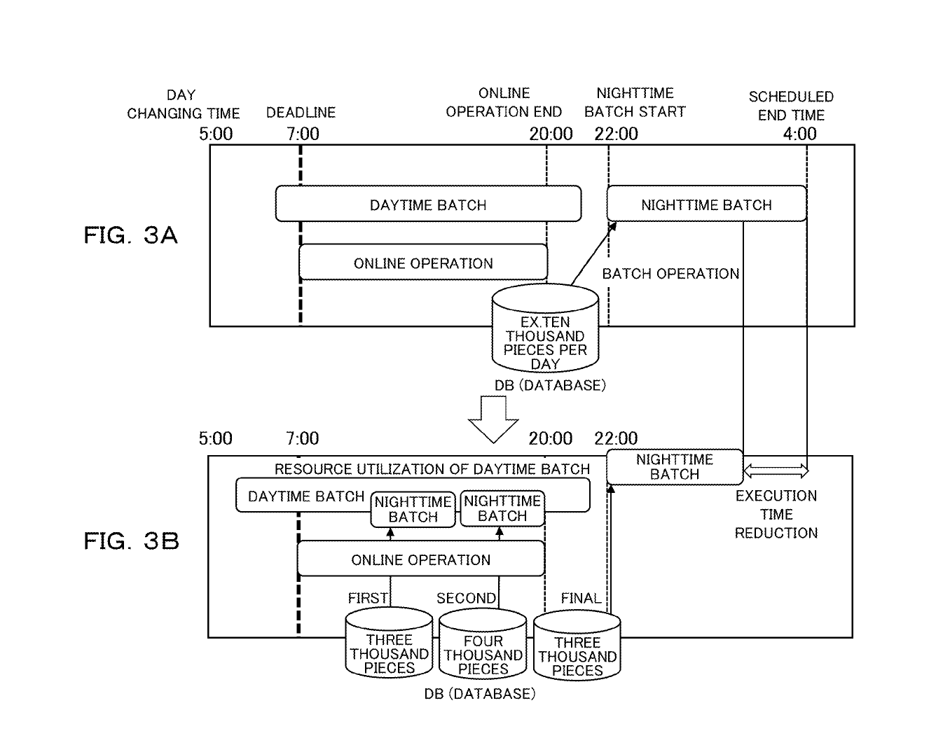

In the processing method of batch operation according to existing technology, as shown in FIG. 3A, after an online operation result for one day, for example, ten thousand pieces are ready, nighttime batch operation on data for one day is performed collectively. FIG. 3A is a diagram illustrating an overview of the processing method of batch operation according to the existing technology.

In contrast, in the processing method of batch operation according to the present embodiment, as shown in FIG. 3B, a portion of batch operation is divided and performed in parallel with the online operation in a time zone of the online operation. For the operation, resources of daytime batch are utilized. Then, in the example shown in FIG. 3B, after the first batch operation on the online operation result of first three thousand pieces is performed in parallel with online operation, the second batch operation on the online operation result of next four thousand pieces is performed in parallel with the online operation. Then, in the nighttime batch, the final batch operation on the online operation result of three thousand pieces is performed. In this manner, nighttime batch operation on the online operation results of seven thousand pieces is moved forward to a period of online operation and performed and so the execution period (execution time) of nighttime batch can be shortened by the execution time of batch operation performed by being moved forward. FIG. 3B is a diagram illustrating an overview of the processing method of batch operation in the present embodiment.

The batch operation will briefly be described here. The batch operation is normally divided into a daytime batch and a nighttime batch and each has the following characteristics. In the present embodiment, batch operation including the daytime batch and nighttime batch may be called a “job net” and the batch job may simply be called a “job”.

The daytime batch (also called a batch during on or an online batch) is a batch in which data generated during online operation is sequentially processed or when a certain amount of data is accumulated. The daytime batch processes a small amount of data and the processing time thereof is not long. In addition, the daytime batch is processed during online operation and so no deadline is normally set.

The nighttime batch is a batch in which data accumulated during online operation is processed collectively after online operation. A large amount of data is processed collectively in the nighttime batch and thus, the processing time thereof becomes longer. In addition, the nighttime batch, in which data after online operation is processed collectively, needs to be completed before data is accumulated in the next online operation and thus, a deadline is set thereto.

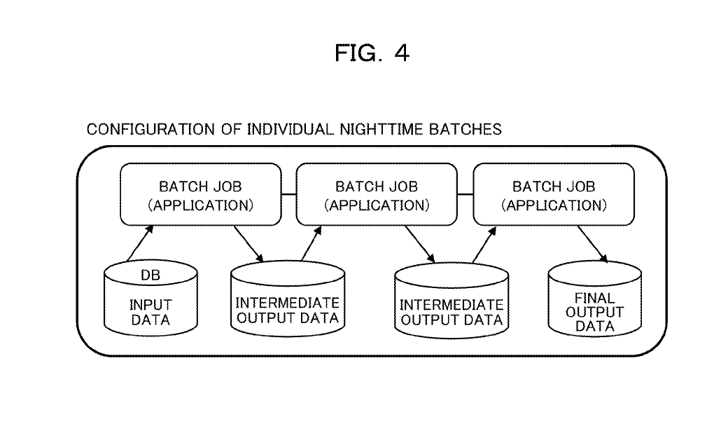

Individual nighttime batches have the configuration shown in, for example, FIG. 4. FIG. 4 is a diagram showing the configuration of nighttime batch operation. As shown in FIG. 4, the nighttime batch includes a plurality (three in FIG. 4) of batch jobs (applications). Input data (data segments obtained by online operation) from DB is input into the first batch job and first intermediate output data is obtained as a operation result of the first batch job. The first intermediate output data is input into the second batch job and second intermediate output data is obtained as a operation result of the second batch job. Then, the second intermediate output data is input into the last batch job and final intermediate output data is obtained as a operation result of the last batch job.

### [1-2-1] Solution to the Technical Problem I (1)

Here, the method in the present embodiment that extracts a job of the type corresponding to the item A1 processed for each record without modifying applications as resources of the operator (client) will be described.

By focusing on DB of online operation results as input data of batch jobs and intermediate output data of batch jobs, a job of the type of the item A1 processed for each record (one data segment) will be inferred by procedures i and ii below.

Procedure i: Determine whether each job is a job (extraction job) that performs data extraction processing by using DB of online operation results as input.

Procedure ii: Infer a job that processes one record after another starting with the data segment extracted in the extraction job and the number of data segments (pieces of intermediate output data) output by the processing is N times (N is an integer equal to 1 or greater) the number of extracted data segments as a job of the type of the item A1 (forward movable job). Subsequent jobs for which the number of pieces of intermediate output data is an integral multiple of the number of input data segments are set collectively as a job group that can be moved forward.

Details of the above procedures i and ii will be described in (B1) of the item [1-4-1] described below.

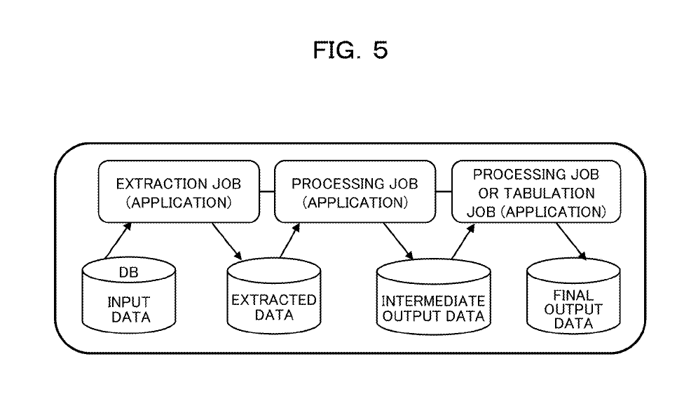

The extraction job will be described here. The extraction job is a job that performs processing to extract data from DB and a job that extracts data matching extraction conditions from input data (DB) to a file. The nighttime batch that collectively processes a large amount of data is configured by, as shown in FIG. 5, combining an extraction job, a processing job, and/or a tabulation job. The processing job is a job that processes extracted data extracted from input data by an extraction job. The tabulation job is a job that tabulates the extracted data or intermediate output data obtained after being processed by the processing job. FIG. 5 is a diagram showing the configuration of the nighttime batch operation in more detail to illustrate an extraction job.

Characteristics of a general extraction job include four characteristics (a1) to (a4) shown below. Then, by trapping a portion of a processing request issued by an application to OS (Operating System) to analyze whether the application includes the characteristics (a1) to (a4) shown below of an extraction, whether the application is an extraction job can automatically be recognized.

(a1) An extraction application reads an input file in units of records or a certain size in order from the start to the end.

(a2) If the value of some column of a record matches extraction conditions specified for an extraction application, the extraction application writes the relevant record into an output file in units of records or a certain size in order (no record processing).

(a3) An extraction application is not fixed to one output file and distributes output to a plurality of output files following extraction conditions. When the plurality of output files exists, the relationship between extraction conditions and output files is predefined in an extraction condition definition file.

(a4) The extraction condition definition file is expanded to the memory by read processing at a time.

### [1-2-2] Solution to the Technical Problem I (2)

Here, the method in the present embodiment that identifies the range of a plurality of jobs (job group) that can be moved forward in consideration of the flow of data affecting the whole batch operation will be described. In the present embodiment, a job group that can be moved forward is identified by procedures iii and iv below.

Procedure iii: If a job including cooperation processing that delivers information to other operations (processing), that is, a job including processing of insert, update, or delete of data from a business DB is contained in the job group that can be moved forward, exclude the job group from jobs to be moved forward. Details of the procedure iii will be described in (B2) of the following item [1-4-1].

Procedure iv: If a predetermined output job (terminating job or end job) as described below is contained in subsequent jobs of an extracted job in a job group determined to be forward movable, set jobs from the extracted up to the subsequent job immediately before the predetermined output job as the range of a job group that can be moved forward. The predetermined output job is a job that delivers final output data to subsequent batch operation through file creation/file transfer, that is, a job that performs message issuing processing or file transfer processing. Alternatively, the predetermined output job is a job whose output file is an activation trigger (start trigger) of other batch operation (another operation). Details of the procedure iv will be described in the following item [1-4-2].

### [1-2-3] Solution to the Technical Problem II

Here, the method in the present embodiment that exercises control such that the final output result is output correctly by utilizing divided data without doubly processing input data even if batch operation is performed a plurality of times will be described. In the present embodiment, the control is exercised by procedures v and vi below.

Procedure v: Enable the control of an input/output file to solve the technical problem II by identifying an extraction job (extracted data to be input) and identifying an application (processing job) that performs processing in the range of single input data thereof as a target to be moved forward. In addition, execution timing (forwarded execution time) of an extracted job group is set/recorded in accordance with processing conditions of a plurality of pieces of predetermined operation (online operation). Then, a temporary input file and a temporary output file of the job group moved forward are created in accordance with the number of times of forwarded execution so that the range of data processed up to the execution timing can correctly be recognized. Details of the procedure v will be described in the following item [1-8-1].

Procedure vi: A job group that can be moved forward is moved forward and executed on unprocessed data obtained by excluding processed data after comparing an input file and input data during execution of divided batch operation immediately before so that double processing should not occur in the second and subsequent divided batch operation. If the execution timing reaches the start time of the nighttime batch, the result (temporary output file) of processing moved forward and performed as the final batch operation is merged. Details of the procedure vi will be described in the following item [1-8-2].

### [1-3] Overview of the Processing Method of Batch Operation According to the Present Embodiment

The processing method of batch operation according to the present embodiment roughly includes five pieces of processing P1 to P5 shown below.

P1: Extracts nighttime batches that can be moved forward and executed and the range of forward movable processing (jobs) during test operation of a business operation system.

P2: Calculates a correlation between the transaction amount per unit time of DB used by a batch job and the execution time of the job during test operation of a business operation system.

P3: Monitors for an increase of the transaction amount with each DB in daily operation (actual operation) to determine whether it is necessary to perform batch operation by moving the processing forward.

P4: Selects nighttime batch operation to be moved forward to the daytime and also determines the execution start time of the nighttime batch operation in the daytime during actual operation.

P5: Exercises control such that batch operation is correctly performed even if the batch operation is performed a plurality of times by utilizing data moved forward and processed.

### [1-4] Processing P1

Processing P1 is processing of preparations and, as described above, processing that extracts nighttime batches that can be moved forward and executed and the range of forward movable processing (jobs) during test operation and performs processing of the following items [1-4-1] to [1-4-3].

### [1-4-1] Extraction of Forward Movable Nighttime Batch Operation to an Online Operation Period

Normally, data accumulated after online operation being performed thereon is collectively processed by the nighttime batch. To move data from a nighttime batch operation period to an online operation period in the daytime, it is necessary to be able to independently process each data segment accumulated up to arbitrary timing.

Processing that can independently be performed includes, for example, processing that creates a sales slip for each piece of sales data input online by a sales office.

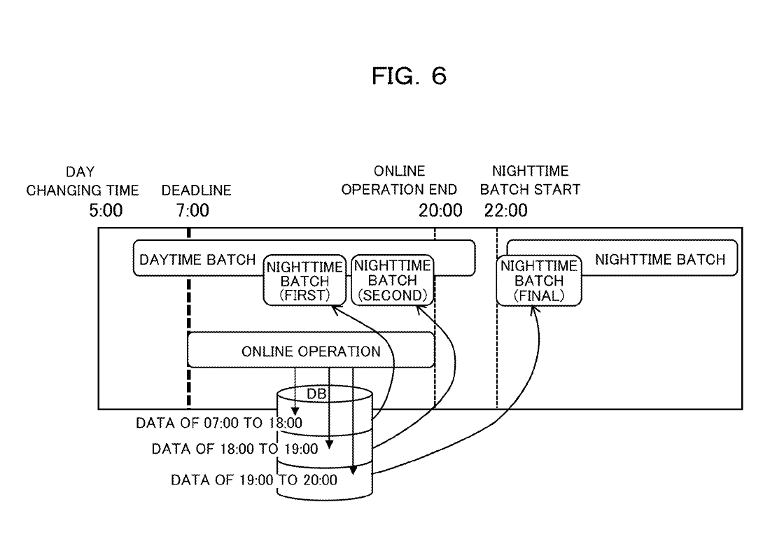

Even in a set of batch operation that performs analysis or tabulation processing in the end, extraction processing of target data and processing to process each piece of data can independently process, as shown in FIG. 6, data accumulated up to arbitrary timing.

FIG. 6 is a diagram illustrating the nighttime batch operation (job) that can independently be executed after being divided. If nighttime batch operation can independently be performed, as shown in FIG. 6, a nighttime batch executed collectively in the nighttime can be divided into, for example, three pieces (first, second, and final) and performed. In the example shown in FIG. 6, data processed online between 7:00 and 18:00 is processed in the first nighttime batch starting at 18:00 by being moved forward. Also, data processed online between 18:00 and 19:00 is processed in the second nighttime batch starting at 19:00 by being moved forward. Then, data processed online between 19:00 and 20:00 is processed in the final nighttime batch starting at 22:00.

In the present embodiment, processing in the following items (B1) and (B2) is performed to extract forward movable nighttime batch operation.

(B1) Extract of jobs that can independently be executed after being divided for each data segment accumulated up to arbitrary timing, that is, forward movable jobs

Jobs that can independently be executed after being divided for each data segment accumulated up to arbitrary timing means that the jobs can be executed after dividing data.

Processing (job) having such characteristics in the batch operation in a business operation system can be determined by the following way of thinking. That is, data segments extracted by extraction processing in an extraction job are processed one by one in the processing (job) and the number of pieces of output data by the processing is equal to the number of pieces of extracted data or N times (integral multiple) the number of pieces of extracted data. In this case, the extraction job to be a starting point to evaluate the 1: N relationship can be recognized by the method described in the above item [1-2-1].

Processing that cannot be performed before all data (for example, data for one day in daily processing) is read includes, for example, analysis or tabulation processing. The number of pieces of data output by such processing is not in a proportional relationship to the number of pieces of input data (for example, data extracted by extraction processing) and, for example, several output results are obtained from 1000 pieces of input data.

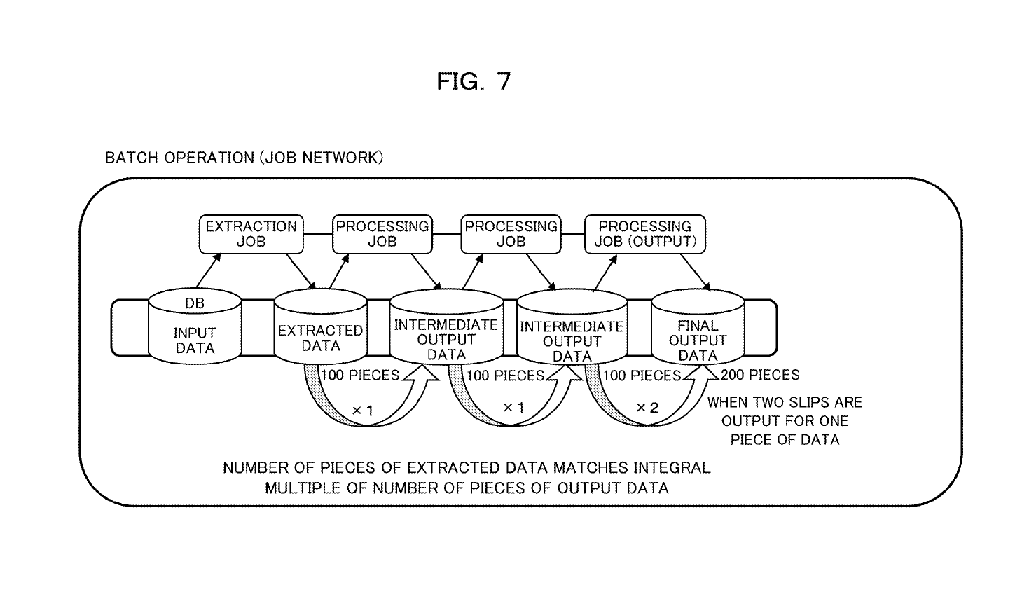

A job group that performs processing as shown in FIG. 7 can independently be executed after being divided for each data segment accumulated up to arbitrary timing. FIG. 7 is a diagram illustrating the nighttime batch operation (job) that can independently be executed after being divided. In the example shown in FIG. 7, the number of pieces of extracted data extracted from input data in the extraction job is 100 and in the first processing job, 100 pieces of intermediate output data are obtained from 100 pieces of input data (extracted data). Also in the second processing job, 100 pieces of intermediate output data are obtained from 100 pieces of input data (intermediate output data). Then, in the final processing job (output), 200 pieces of intermediate output data are obtained from 100 pieces of input data (intermediate output data). In the example shown in FIG. 7, therefore, all of the extraction job and three processing jobs are extracted and identified as nighttime batch operation that can independently be performed by being divided, that is, as forward movable nighttime batch operation.

The aforementioned forward movable job group is identified by procedures (B1-1) to (B1-6) described below. Incidentally, the extraction job is assumed to be identified and clarified by the method described in the above item [1-2-1].

(B1-1): If an input data file of an extraction job is created by preceding batch operation (job net), the job group containing the extraction job is determined to be “not to be moved forward”. This is because such a job group can be executed only after completion of the preceding batch operation (job net) and cannot be moved forward to the daytime.

(B1-2): Count the number of pieces of output data (extracted data) of the extraction job and store the number as the “number of pieces of input data”.

(B1-3): Determine whether a subsequent job (normally, a processing job or a tabulation job) of the extraction job uses output data of a preceding job and the number of pieces of output data of the job matches an integral multiple of the “number of pieces of input data”.

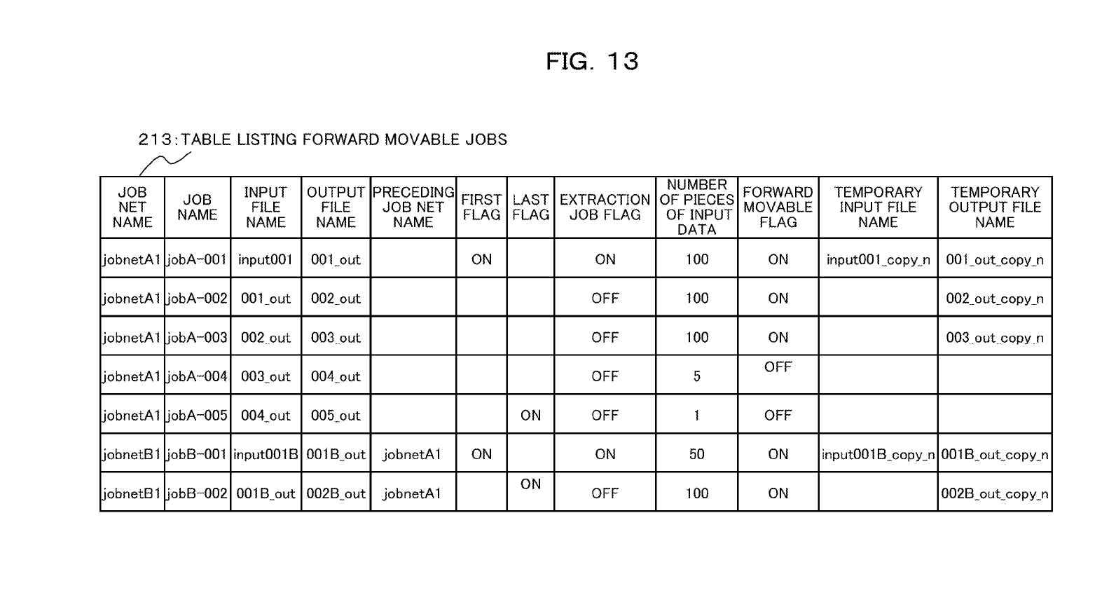

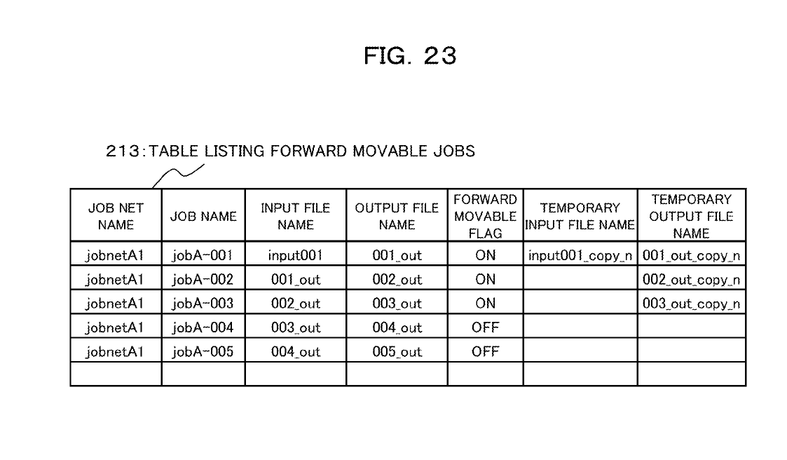

(B1-4): If the determination result of the procedure (B1-3) is “false”, determine the job group “not to be moved forward” and set “OFF” to the forward movable flag in a table 213 listing forward movable jobs, described later (see FIGS. 13 and 23).

(B1-5): If the determination result of the procedure (B1-3) is “true”, determine the job group “to be moved forward” and set “ON” to the forward movable flag in the table 213 listing forward movable jobs.

(B1-6): Repeat the determination processing of the procedure (B1-3) on the subsequent job until there is no subsequent job.

(B2) Exclusion of jobs when cooperation processing with another operation is included from jobs to be moved forward

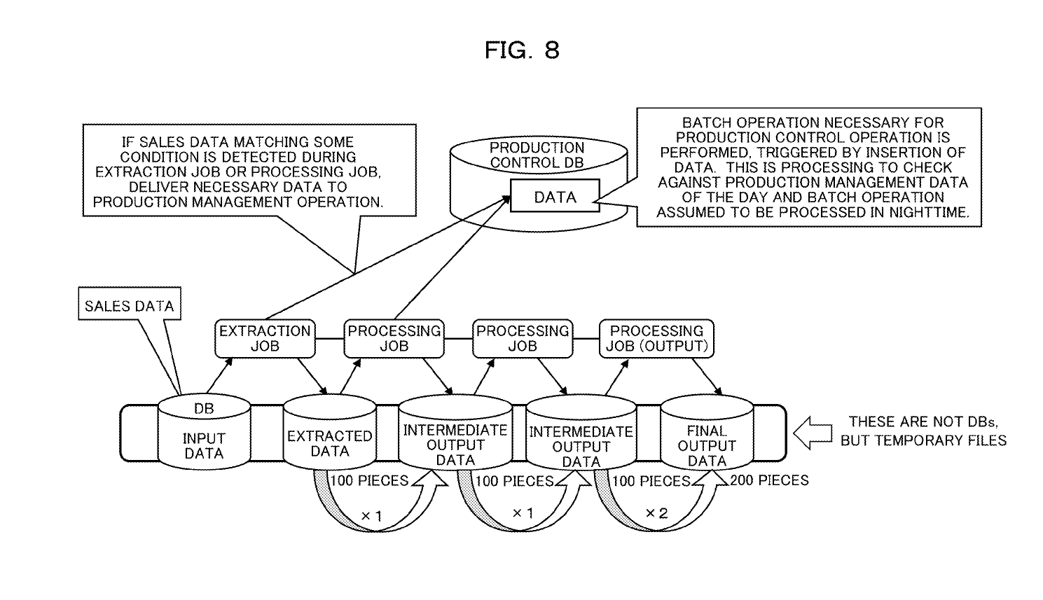

In addition to operation processing as the main purpose, for example, “cooperation processing” that delivers some kind of information or instructions from another operation may be contained in the job group and the cooperation processing is normally performed via DB in which operation data is stored. Such a situation is shown in FIG. 8. FIG. 8 is a diagram illustrating cooperation processing. In the example shown in FIG. 8, when sales data matching some condition is detected during execution of the extraction job (or a processing job), the relevant job delivers necessary data to a production management operation via a production management DB. Then, batch operation needed for the production management operation is performed, triggered by the insertion of data into the production management DB. Such batch operation is processing that checks against production management data of the day and batch operation assumed to be performed in the nighttime.

If a job group containing the aforementioned cooperation processing is moved forward to the daytime (online operation time zone), batch operation of another operation (production management operation in the example shown in FIG. 8) will operate in the daytime. Because the batch operation (batch operation of the production management operation) is assumed to operate in the nighttime, operating the batch operation in the daytime has an adverse effect. Thus, a job group containing the cooperation processing as described above needs to be excluded from jobs to be moved forward.

In the present embodiment, therefore, all jobs belonging to a job group determined to be “forward movable” by the processing in the item (B1) are checked for processing of insert, update, and delete from DB. If the relevant processing is found, the relevant job group is excluded from jobs to be moved forward.

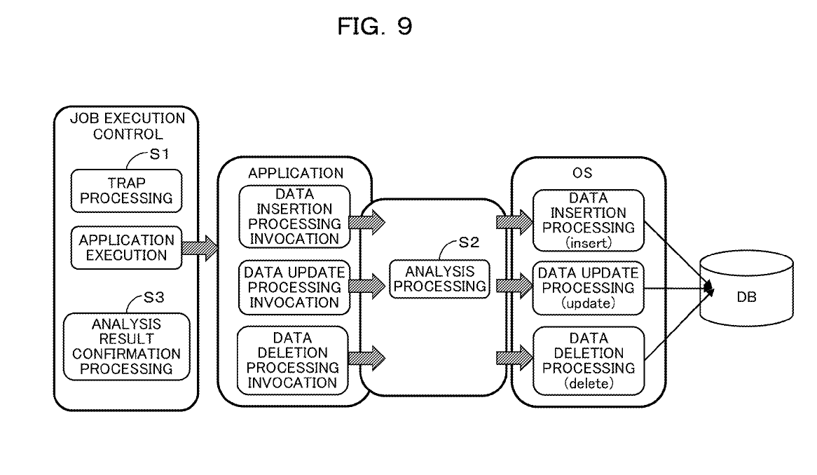

A batch that performs processing of insert, update, or delete from DB traps insertion/update/deletion processing of data of an application executed as a job (see processing S1 in FIG. 9) and performs analysis processing (see processing S2 in FIG. 9). Then, by checking the result of the analysis (see processing S3 in FIG. 9), the presence of insertion/update/deletion processing of data is checked. The trap processing is realized by, for example, the function of DBMS (DataBase Management System). FIG. 9 is a diagram illustrating a checking method of a job (application) including insertion processing, update processing, or deletion processing of data from DB.

### [1-4-2] Extraction of the Range of Forward Movable Jobs

Next, up to which processing (job) of a forward movable job group can be moved forward is selected, that is, the range of actually forward movable jobs in a forward movable job group is extracted.

If all jobs from the extraction job to the terminating job in a job group are determined to be forward movable, the terminating job is processing that outputs data for a business purpose and outputs, for example, sales slip data in CSV (Comma Separated Values) format.

When subsequent operation is performed in the nighttime batch of the day after waiting for final output data, creating output data by moving forward to the daytime has an adverse effect. When, for example, sales slip data is tabulated by subsequent operation after waiting for the sales slip data output in CSV format, tabulation needs to be performed on resultant data processed collectively in the nighttime batch. Nevertheless, if data processed by being moved forward and divided is waited for and operated, correct tabulation is not able to be performed.

Thus, in the present embodiment, when the above case applies, the range from the extraction job to the job one job before (immediately before) the job that creates the final output data is selected as jobs to be moved forward.

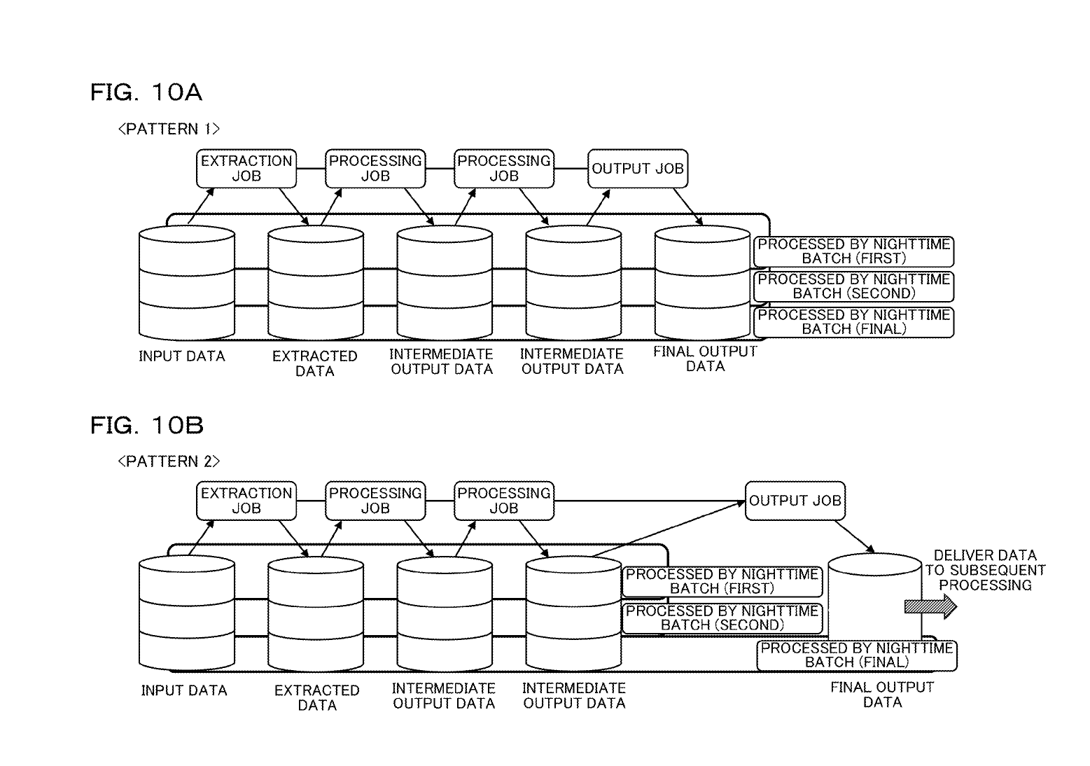

Therefore, two patterns, Pattern 1 and Pattern 2 shown in FIGS. 10A and 10B respectively are available as patterns in which batch operation is moved forward and performed. FIG. 10A is a diagram illustrating Pattern 1 of the range of jobs to be moved forward and FIG. 10B is a diagram illustrating Pattern 2 of the range of jobs to be moved forward.

In Pattern 1 shown in FIG. 10A, the terminating job (output job) does not deliver data to subsequent operation and thus, all jobs from the extraction job to the terminating job in the job group can be moved forward and executed without causing an adverse effect.

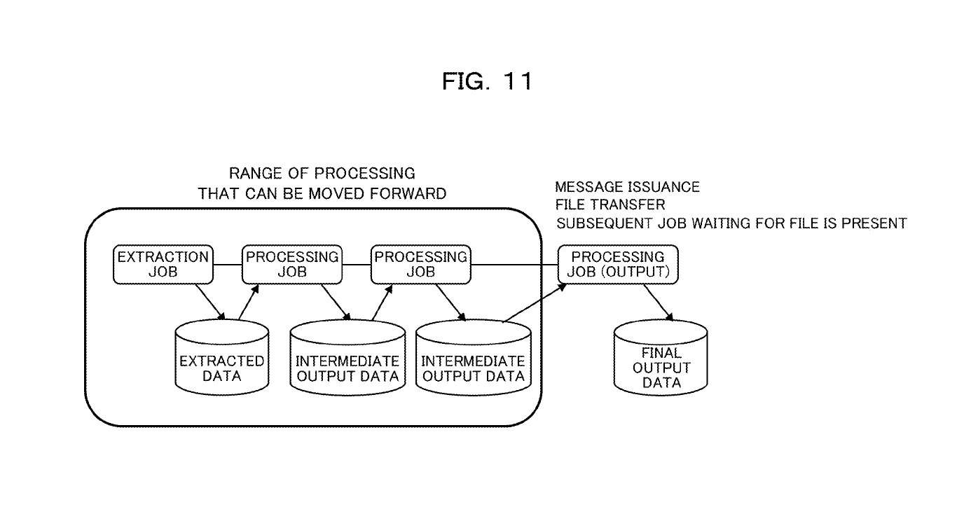

In Pattern 2 shown in FIG. 10B, the terminating job (output job) delivers data to subsequent operation and thus, the range from the extraction job to the job one job before (immediately before) the terminating job is selected as jobs to be moved forward. Whether or not a forward movable job group corresponds to Pattern 2 is determined more concretely as shown below. As shown in FIG. 11, in the following three cases (b1) to (b3) in which subsequent operation is performed using a result of the output job, the range from the extraction job to the job immediately before the output job is selected as jobs to be moved forward. FIG. 11 is a diagram illustrating the range of processing that can be moved forward concerning Pattern 2 in FIG. 10B.

(b1) The output job executes message issuing processing.

(b2) The output job executes file transfer processing.

(b3) An output result file of the output job is an activation trigger/start trigger of another operation (next job).

Whether or not a forward movable job group corresponds to the above item (b1) or (b2) can be determined by referring to the job definition of the final job of an operation (job net). On the other hand, whether or not a forward movable job group corresponds to the above item (b3) can be determined by referring to the job definition of the first job of the next operation (job net) to which data is delivered from the job group.

### [1-4-3] Creation of a Table Listing Forward Movable Jobs

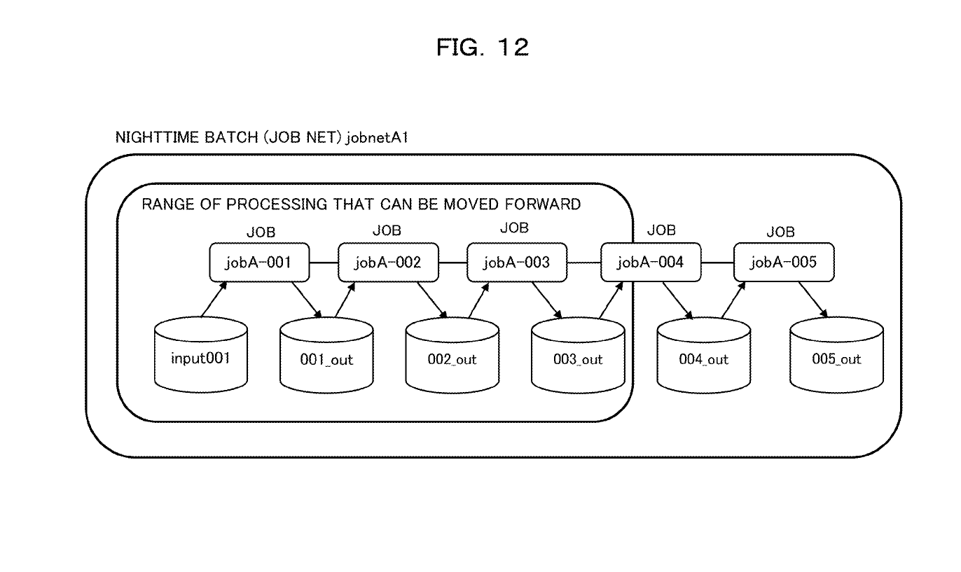

In the present embodiment, the table 213, listing forward movable jobs, of the nighttime batch as shown in FIG. 13 is created for a job net as shown in FIG. 12 according to the processing of the above items [1-4-1] and [1-4-2]. FIG. 12 is a diagram showing a configuration example the nighttime batch (job net) intended for creating a table listing forward movable jobs. FIG. 13 is a diagram showing an example of the table 213, listing forward movable jobs, according to the present embodiment created for the nighttime batch (job net) shown in FIG. 12.

The job to be moved forward is a job whose forward movable flag is “ON” from the start of a job net. The terminating job to be moved forward is the job immediately before the job whose forward movable flag is “OFF” as the first job according to the execution order among a series of jobs in the job net. In the table 213 listing forward movable jobs, a temporary input file name and a temporary output file name needed to perform Processing P5 described in the item [1-8] described below for a job whose forward movable flag is “ON” are set.

In each record of the table 213, listing forward movable jobs, shown in FIG. 13, the job net name, job name, input file name, output file name, preceding job net name, beginning flag (first flag), terminating flag (last flag), extraction job flag, number of pieces of input data, forward movable flag, temporary input file name, and temporary output file name are set. Information related to a nighttime batch (job net) jobnetA1 including five jobs jobA-001 to jobA-005 as shown, for example, FIG. 12 to the above five records of the table 213 shown in FIG. 13. In the example shown in FIG. 12, the job jobA-001 is the extraction job and the three jobs jobA-001 to jobA-003 are included in the forward movable job range.

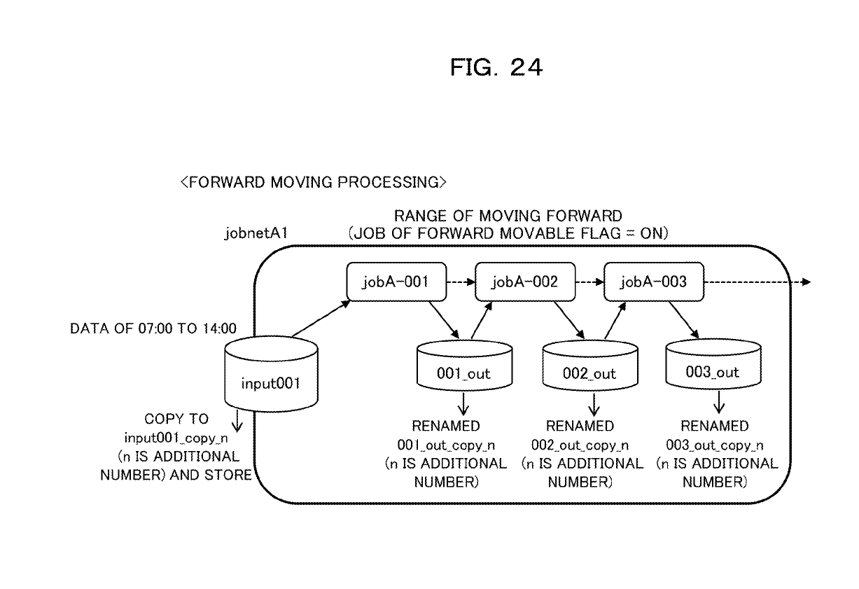

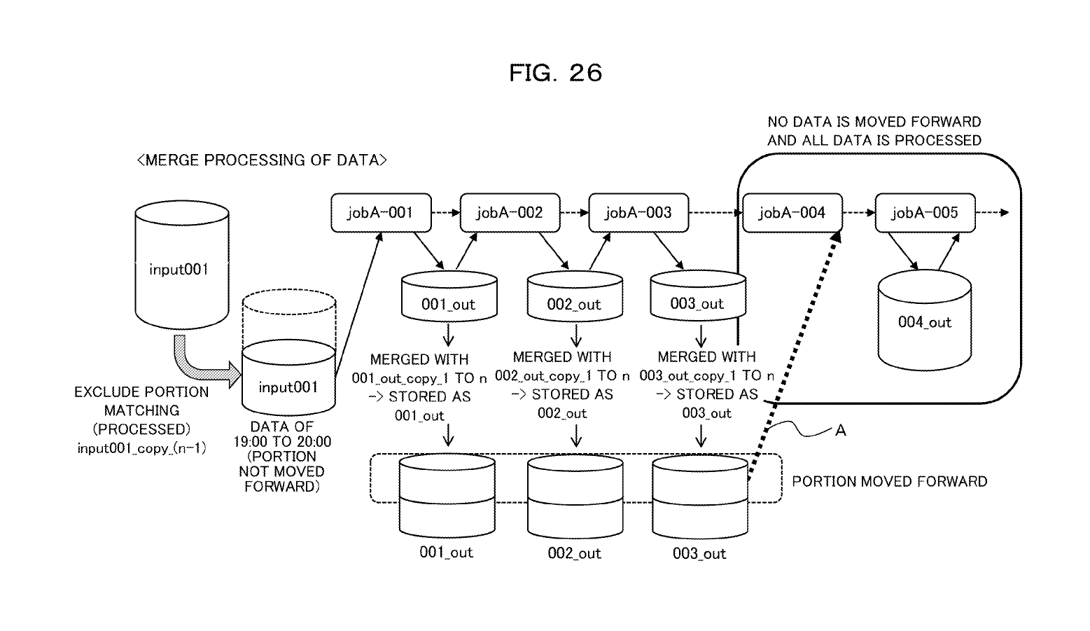

Information related to the job jobA-001 is set to the top record of the table 213. That is, the job net name “jobnetA1” to which the job jobA-001 belongs is set to the field of the job net name and the job name “jobA-001” of the job jobA-001 is set to the field of the job name. The input file name “input001” input into the job jobA-001 and the output file name “001_out” output from the job jobA-001 are set to the fields of the input file name and the output file name respectively. Because there is no preceding job net to the job jobA-001, the field of the preceding job net is empty. The job jobA-001 is the first job (beginning job), an extraction job, and a forward movable job and thus, “ON” is set to the fields of the first flag, the extraction job flag, and the forward movable job the field of the terminating flag (last flag) is empty. Further, “100” is set to the field of the number of pieces of input data input from the job jobA-001 to the next job jobA-002 and “input001_copy_n” and “001_out_copy_n” are set to the fields of the temporary input file name and the temporary output file name respectively. The temporary input file input001_copy_n and the temporary output file 001_out_copy_n will be described later with reference to FIGS. 24 and 26.

In the table 213 shown in FIG. 13, information related to the jobs jobA-002 to jobA-005 shown in FIG. 12 is set in the same manner as the information related to the job jobA-001 and a detailed description thereof is omitted here.

Also in the table 213 shown in FIG. 13, information related to the job net jobnetB1 is also set. A preceding job net exists for the job net jobnetB1 and the job net name “jobnetA1” is set to the field of the preceding job net name of the first job jobB-001 of the job net jobnetB1.

### [1-5] Processing P2

Processing P2 is processing of preparations and, as described above, processing that creates a correlation table between the transaction amount and the execution time during test operation and performs processing of the following items [1-5-1] and [1-5-2].

### [1-5-1] Investigation of DB Accessed by the Nighttime Batch and Creation of a Table in which the Transaction Amount is Stored

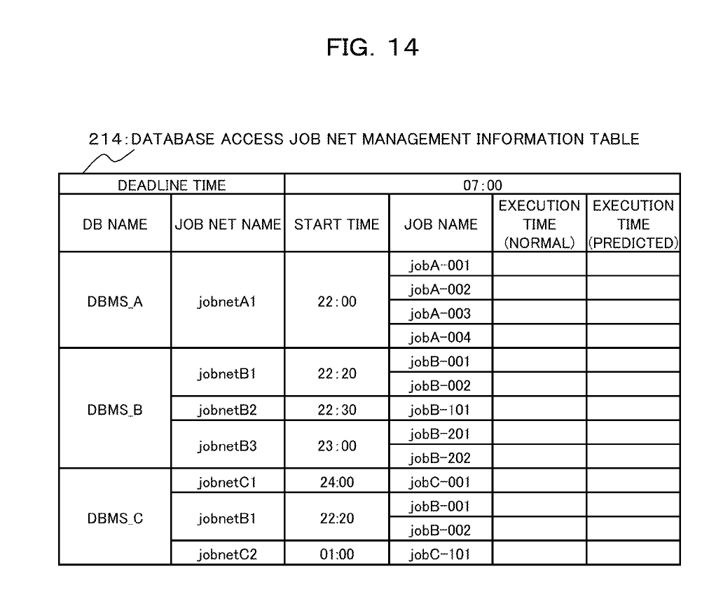

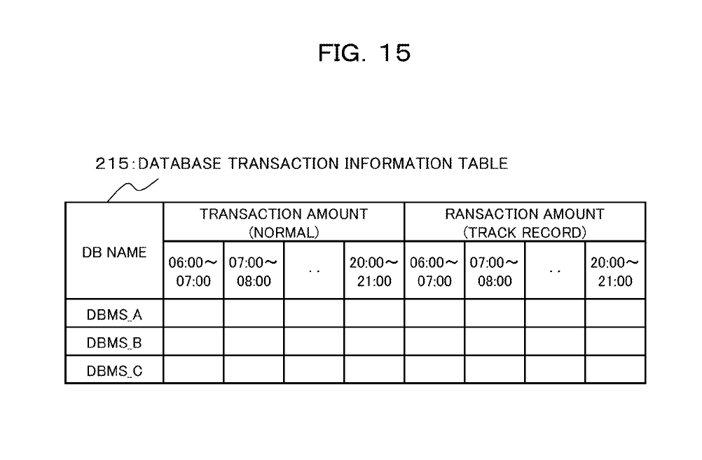

As a preparation, two tables 214, 215 shown in FIGS. 14 and 15 respectively are created by DB to be accessed by the nighttime batch being investigated. FIG. 14 is a diagram showing an example (initial state) of the database access job net management information table 214 according to the present embodiment. FIG. 15 is a diagram showing an example (initial state) of the database transaction information table 215 according to the present embodiment.

### [1-5-1-1] Database Access Job Net Management Information Table

In the database access job net management information table 214, as shown in FIG. 14, information about a job net (nighttime batch) accessing each DB and information about the execution time of each job belonging to the job net are stored. Information stored in the table 214 includes the following items (c1) to (c7).

(c1) Deadline time: This is the start time of the online operation and a job net executed in the nighttime needs to be completed by this time. In FIG. 14, for example, the time 7:00 is set.

(c2) DB name: DB name of DB accessed by the job net. In FIG. 14, for example, DBMS_A, DBMS_B, and DBMS_C are set.

(c3) Job net name: Job net name of a job net accessing each DB. Because a plurality of DBs may be accessed from one job net, the same job net name may be associated with a plurality of DB names. In FIG. 14, for example, jobnetA1, jobnetB1, jobnetC1 and the like are set.

(c4) Start time: Start time of each job net (nighttime batch)

(c5) Job name: Job name of a job registered in a job net

(c6) Execution time (normal): Execution time of each job (time needed to execute each job). As will be described in the following item [1-5-2], this is information collected during test operation. The field of the execution time (normal) in the initial state immediately after the table 214 is created is empty.

(c7) Execution time (predicted): Predicted execution time of each job. As will be described in the following item [1-6-2], this is information predicted based on the transaction amount collected during test operation. The field of the execution time (predicted) in the initial state immediately after the table 214 is created is empty.

### [1-5-1-2] Database Transaction Information Table

In the database transaction information table 215, as shown in FIG. 15, information about the transaction amount per unit time (one hour here) with each DB in the processing time zone (6:00 to 21:00) of the daytime batch is stored. Information stored in the table 215 includes the following items (d1) to (d3).

(d1) DB name: DB name of DB accessed by a job net. The same DB name as the DB name set to the database access job net management information table 214 is set. In FIG. 15, for example, DBMS_A, DBMS_B, and DBMS_C are set.

(d2) Transaction amount (normal): Transaction amount with each DB per unit time (for example, one hour). As will be described in the following item [1-5-2], this is information collected during test operation. The field of the transaction amount (normal) in the initial state immediately after the table 215 is created is empty.

(d3) Transaction amount (track record): Transaction amount with each DB per unit time (for example, one hour). As will be described in the following item [1-6-1], this is information collected during actual operation. The field of the transaction amount (track record) in the initial state immediately after the table 215 is created is empty.

### [1-5-2] Recording in the Database Access Job Net Management Information Table and the Database Transaction Information Table

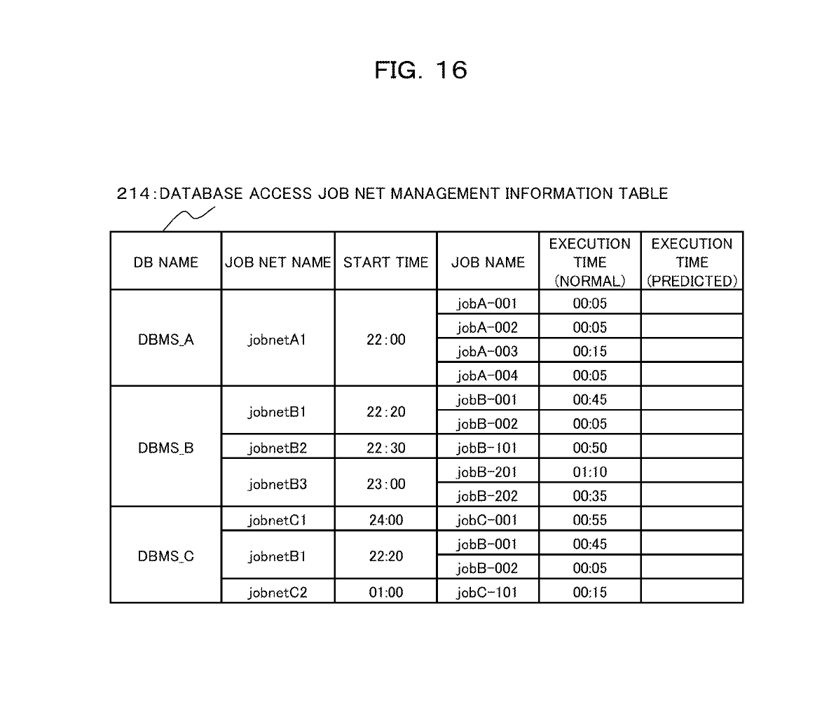

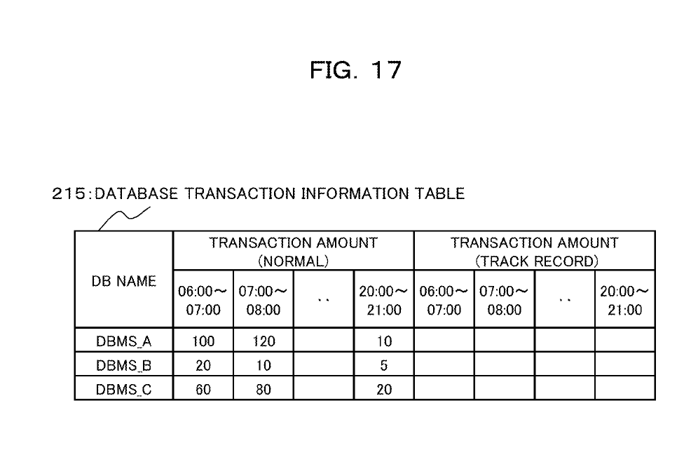

In a test operation of a business operation system, the time needed for executing each job is collected and recorded, as shown in FIG. 16, in the field of the execution time (normal) of the database access job net management information table 214. Also in the test operation of the business operation system, the transaction amount per unit time of a daytime batch with each DB is also collected and recorded, as shown in FIG. 17, in the field of the transaction amount (normal) of the database transaction information table 215.

FIG. 16 is a diagram showing an example of the database access job net management information table 214 in which the execution time (normal) of each job collected in a test operation is recorded. FIG. 17 is a diagram showing an example of the database transaction information table 215 in which the transaction amount (normal) with each DB collected in the test operation is recorded.

### [1-6] Processing P3

Processing P3 is processing during actual operation and, as described above, processing that monitors for an increase of the transaction amount with each DB in daily operation to determine whether it is necessary to perform batch processing by moving the processing forward and performs processing of the following items [1-6-1] and [1-6-2].

### [1-6-1] Monitoring of the Transaction Amount

When the actual operation of the business operation system is started, the actual transaction amount with each DB per unit time (one hour) is collected.

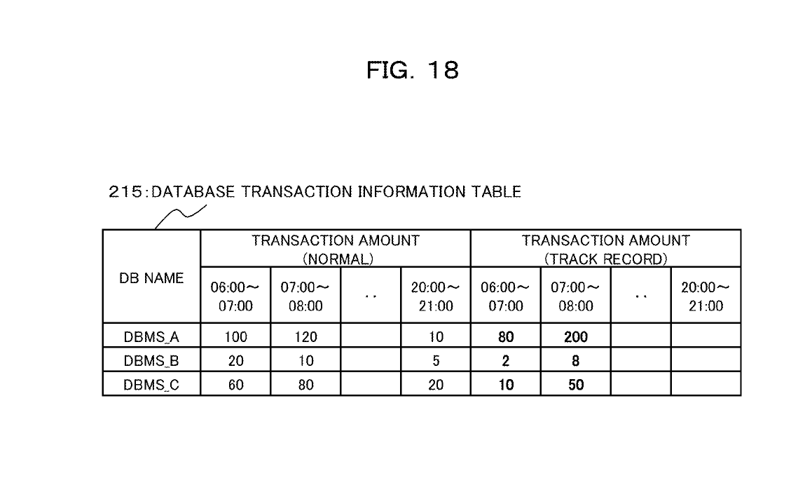

The collected actual transaction amount is set to, as shown in FIG. 18, the field of the transaction amount (track record) of the database transaction information table 215. In the database transaction information table 215 shown in FIG. 18, actual transaction amounts with the databases DBMS_A, DBMS_B, DBMS_C at 7:00 and at 8:00 are recorded as transaction amounts (track record). FIG. 18 is a diagram showing an example of the database transaction information table 215 in which the transaction amount (track record) with each DB collected in an actual operation is recorded.

### [1-6-2] Determination of Necessity of Moving Batch Operation Forward for Execution

Then, a determination is made whether it is necessary to move batch operation forward as described below. That is, based on the actual transaction amount per unit time in the table 215 and the execution time (normal) of each job in the table 214 collected during test operation, the execution time of the job net for the day is predicted. Here, the prediction method of the execution time of the job net jobnetA1 in the following two examples, Example 1 and Example 2, will be described.

### [1-6-2-1] Example 1

In Example 1, the prediction method when there is no abrupt increase in data, for example, the method of predicting the execution time of the job net jobnetA1 at 7:00 in FIG. 18 will be described.

As shown in FIG. 18, the transaction amount (normal) between 6:00 and 7:00 in the test operation is 100 and the transaction amount (track record) between 6:00 and 7:00 in the actual operation is 80. The execution time of the job net jobnetA1 in the test operation is the sum of execution times (normal) of the four jobs jobA-001 to jobA-004, that is, 00:30 (30 min).

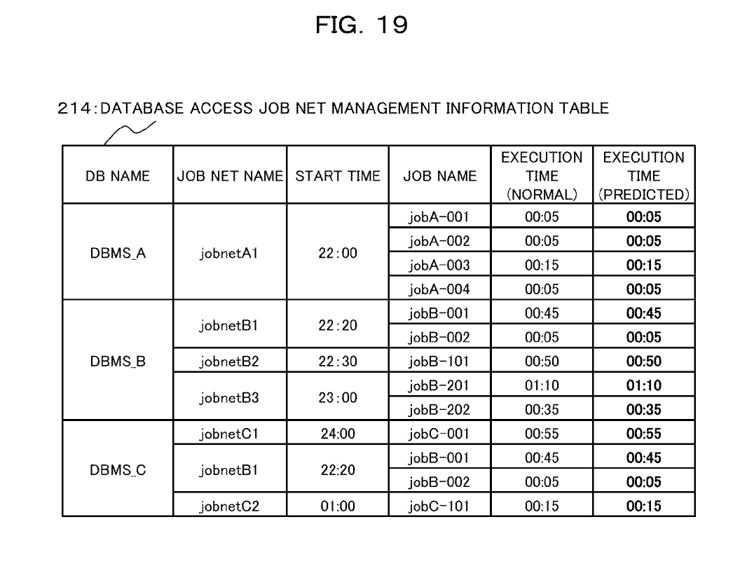

In this case, the transaction amount of 80 in the actual operation is smaller than the transaction amount of 100 in the test operation and so no abrupt increase in data is considered to have occurred. When no increase in data is considered to have occurred, as shown in FIG. 19, the time of the execution time (normal) in the test operation is directly set to the field of the execution time (predicted) of the database access job net management information table 214. FIG. 19 is a diagram showing an example of the database access job net management information table 214 in which the execution time (predicted) when there is no increase of the transaction amount during actual operation is recorded.

### [1-6-2-2] Example 2

In Example 2, the method of predicting the execution time when there is an increase in data, for example, the execution time of the job net jobnetA1 at 8:00 in FIG. 18 will be described.

As shown in FIG. 18, the transaction amount (normal) between 7:00 and 8:00 in the test operation is 120 and the transaction amount (track record) between 7:00 and 8:00 in the actual operation is 200. The execution time of the job net jobnetA1 in the test operation is the sum of execution times (normal) of the four jobs jobA-001 to jobA-004, that is, 00:30 (30 min).

In this case, the transaction amount of 200 in the actual operation is larger than the transaction amount of 120 in the test operation and so an increase in data is considered to have occurred. When an increase in data is considered to have occurred, the sum of transaction amounts per unit time in the past is calculated for each of the test operation and the actual operation and the sum for the test operation and the sum for the actual operation are compared.

That is, the sum of transaction amounts between 6:00 and 8:00 in the test operation is 100+120=220 and the sum of transaction amounts between 6:00 and 8:00 in the actual operation is 80+200=280. Comparing these sums shows that the sum of the actual operation is larger than the sum of the test operation. In this case, the execution time of nighttime jobs is predicted by, as shown in the following Formula (1), a ratio calculation.

[Predicted execution time of each job in the nighttime in actual operation]=[execution time in test operation]×[sum of transaction amounts in actual operation]/[sum of transaction amounts in test operation] (1)

In the example shown in FIG. 18, the predicted execution time of the job jobA-001 in the job net jobnetA1 is calculated, based on the above Formula (1), as shown in the following Formula (2):

[Predicted execution time of the nighttime job jobA-001 in actual operation]=5 min×280/220=about 7 min (2)

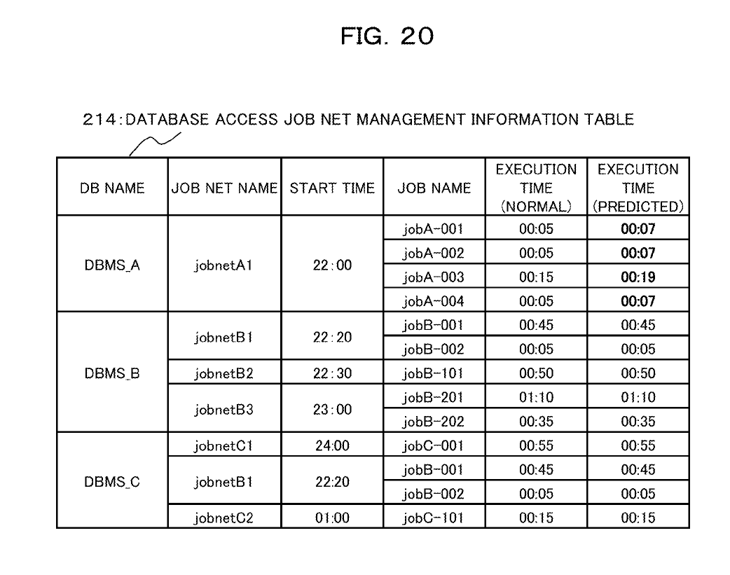

The predicted execution time calculated as described above is set to the field of, as shown in FIG. 20, the execution time (predicted) of the database access job net management information table 214. If information calculated before is set to the field of execution time (predicted), the information is overwritten with the latest predicted execution time. FIG. 20 is a diagram showing an example of the database access job net management information table 214 in which the execution time (predicted) when there is an increase of the transaction amount during actual operation is recorded.

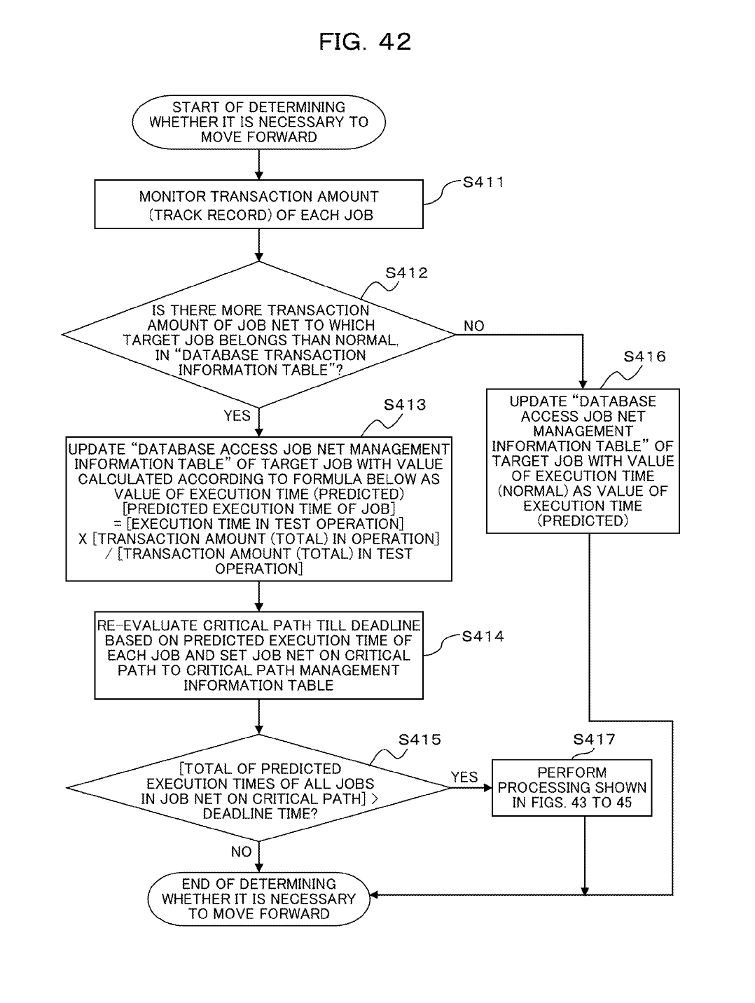

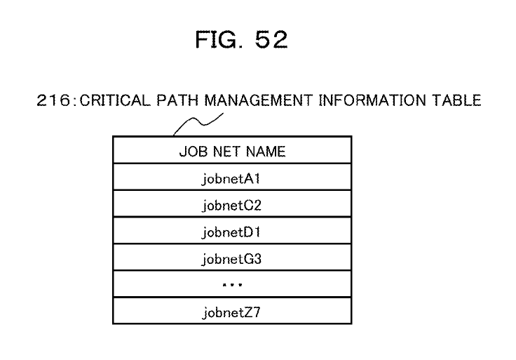

Based on the predicted execution time of each job in the nighttime recorded in the table 214 in this manner, a critical path is calculated and whether the calculated critical path is in time for the deadline time is evaluated. If the evaluation is that the calculated critical path is not in time for the deadline time, that is, the critical path processing is not completed by the deadline time, moving nighttime batch operation forward to the daytime is determined to be necessary. Incidentally, a critical path is managed by a critical path management information table 216 described later with reference to FIG. 52. The evaluation of a critical path will be described later with reference to FIGS. 42, 43, and 52.

### [1-7] Processing P4

Processing P4 is processing during actual operation and, as described above, processing that selects nighttime batch operation to be moved forward to the daytime and also determines the execution start time of the nighttime batch operation in the daytime and performs processing of the following items [1-7-1] and [1-7-2]. That is, Processing P3 described above determines that it is necessary to move nighttime batch operation forward to the daytime, processing of the following items [1-7-1] and [1-7-2] is performed. Incidentally, the nighttime batch operation of the day assumes that the critical path calculated based on the above predicted execution time is identified. A critical path is derived by a common method based on the predicted execution time of each job net.

### [1-7-1] Selection of Nighttime Batch Operation to be Moved Forward to the Daytime

The selection of nighttime batch operation to be moved forward to the daytime is made according to procedures (e1) to (e7) described below.

(e1) Check whether batch operation (job group) that can be moved forward to the daytime exists on the derived critical path of the nighttime batch based on the predicted execution time predicted from an increase of transactions.

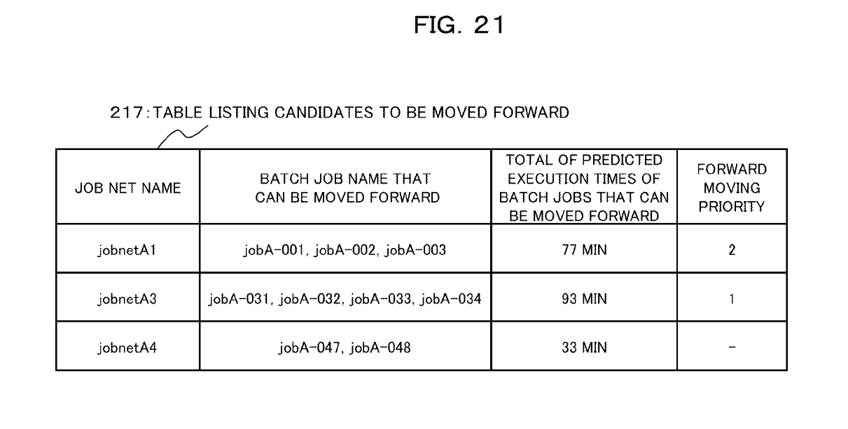

(e2) When batch operation that can be moved forward exists, create a table 217 listing candidates to be moved forward, as shown in FIG. 21 and extract the batch operation of the longest execution time (job net whose forward moving priority is 1). FIG. 21 is a diagram showing an example of the table 217, listing candidates to be moved forward, according to the present embodiment. The table 217 listing candidates to be moved forward is created as described below. That is, among jobs whose forward movable flag in the table listing forward movable jobs 213 is “ON”, jobs present on the critical path are extracted. Then, the total of predicted execution times of batch jobs that can be moved forward is calculated by extracting and totaling the predicted execution time of each extracted job from the database access job net management information table 214 to create the table 217 listing candidates to be moved forward. In this case, the forward moving priority is set in ascending order from “1” in descending order of predicted execution time. In the table 217 listing candidates to be moved forward, the job net name, the job name of a job belonging to a forward movable job group, the total, and the forward moving priority are associated and stored.

(e3) Recalculate an execution time tc of the whole critical path when the batch operation extracted in the above procedure (e2). That is, a value to−tb obtained by subtracting an execution time tb of the batch operation extracted in the procedure (e2) from an execution tom to of the whole original critical path is calculated as the execution time tc. Then, check whether the time Tc+tc obtained by adding the execution time tc(=to−tb) to the start time Tc of the critical path exceeds the deadline time, that is, whether the processing of the whole critical path after being moved forward is completed by the deadline time. If the time Tc+tc is before the deadline time, the processing of the whole critical path is determined to be completed by the deadline time and, on the other hand, if the time Tc+tc exceeds the deadline time, the processing of the whole critical path is determined not to be completed by the deadline time.

(e4) If, as a result of checking the procedure (e3), the processing is determined not to be completed by the deadline time, return to the processing of the procedure (e2) to extract the next batch operation to be moved forward (job net whose forward moving priority is 2). Perform the same operation as in the procedure (e3) on the extracted batch operation to be moved forward. Repeat the processing in the procedures (e2) to (e4) until it is determined in the procedure (e2) that the processing of the whole critical path is completed by the deadline time.

(e5) If it is determined that processing is completed by the deadline time by moving one or a plurality of pieces of batch operation forward, processing in the following item [1-7-2] is performed.

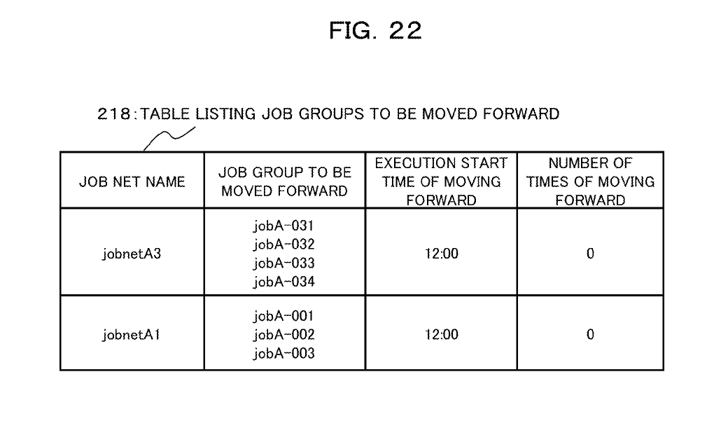

(e6) Create a table 218 listing job groups to be moved forward as shown in FIG. 22 that manages job groups determined to be moved forward and executed. In the table 218 listing job groups to be moved forward, job names of jobs belonging to job groups to be moved forward are held. Also in the table 218 listing job groups to be moved forward, the forwarded execution start time and the number of times of forwarded execution (0 in the initial state) are held and managed. FIG. 22 is a diagram showing an example of the table 218 listing job groups to be moved forward according to the present embodiment.

(e7) If the processing does not apply to the procedure (e5), that is, the processing of the whole critical path is not completed by the deadline time even if all forward movable batch operation registered in the table 217 listing candidates to be moved forward is moved forward and executed, the job group is not moved forward and executed and notification of an alarm is sent to the system administrator or the like.

### [1-7-2] Determination of the Execution Start Time of Nighttime Batch Operation in the Daytime

If the nighttime batch operation to be moved forward to the daytime is selected by the processing in the item [1-7-1], the execution start time of the nighttime batch operation in the daytime is determined by procedures (f1) to (f4) described below.

To realize the method in the present embodiment, the following points need to be considered. To improve the management speed in recent years, there are some cases in which operation processing traditionally processed collectively in the nighttime is performed in the daytime as a daytime batch. Normally, when compared with the nighttime batch, the demand for daytime batch is extremely low and even if the daytime batch operates, generally server resources are always available sufficiently. Thus, in a case in which single multiple to several multiple batch jobs are moved forward from the nighttime to the daytime, there is no need to particularly consider shortages of server resources. However, if an attempt is made to move forward and execute a large amount of nighttime batches in the daytime, there is the possibility of shortages of server resources and therefore, from the viewpoint of server resources, it is necessary to have consideration such that a nighttime batch moved forward does not affect a daytime batch.

(f1) If an increase of transactions is detected and it is determined that nighttime batch operation needs to be moved forward and executed, nighttime batch operation is immediately moved forward and executed. This becomes the first batch operation performed in the daytime. At this point, as shown in FIG. 22, the time (for example, 12:00) is stored in the field of the forwarded execution start time in the table 218 listing job groups to be moved forward.

(f2) If a plurality of pieces of batch operation (job group) that can be moved forward exists in the procedure (f1), the batch operation is started and performed in order in descending order of priority.

(f3) When the batch operation is started and executed in the procedure (f2), an upper limit check of processing multiplicity including daytime batches is made and a job is activated only if the processing multiplicity has not reached the upper limit. When the processing multiplicity reaches the upper limit, batch operation is inhibited from being performed and the inhibited batch operation is started to be performed when a vacancy of processing multiplicity arises.

(f4) Hereinafter, forward movable batch operation is performed every hour until the online operation is closed.

### [1-8] Processing P5

Processing P5 is processing during actual operation and, as described above, processing that exercises control such that batch operation is correctly performed by utilizing data moved forward and executed even if the batch operation is performed a plurality of times and performs processing of the following items [1-8-1] and [1-8-2].

### [1-8-1] Creation of a Temporary Input File and a Temporary Output File

When a job net on a critical path is moved forward and executed in the daytime, the table 213 listing forward movable jobs and the table 217 listing candidates to be moved forward are referred to. Particularly concerning the table 213 listing forward movable jobs, principal portions shown in FIG. 23 is referred to. FIG. 23 is a diagram extracting and showing principal portions from the table 213 listing forward movable jobs, shown in FIG. 13.

In this case, records in the table 213 listing forward movable jobs are referred to one by one starting with the first record and a job whose forward movable flag is “ON” is extracted as the starting point (the job jobA-001 is extracted in the example shown in FIG. 23). Also, among a series of jobs in the same job net, the job immediately before the job whose forward movable flag is “OFF” as the first job according to the execution order is extracted as the end point (the job jobA-003 is extracted in the example shown in FIG. 23). Then, a series of jobs from the job of the starting point to the job of the end point (three jobs jobA-001 to jobA-003 in the example shown in FIG. 23) are moved forward and executed.

As shown in FIG. 24, input data of a job net is stored after the temporary input file name (input001_copy_n in FIG. 23) set to the table 213 listing forward movable jobs being attached. The output file for each job is stored after being renamed the temporary output file name (001_out_copy_n to 003_out_copy_n in FIG. 23) set in the table 213 listing forward movable jobs. FIG. 24 is a diagram illustrating forwarded processing according to the present embodiment.

“n” in the temporary input file name and the temporary output file name in FIGS. 23 and 24 is the number of times of forwarded execution stored and managed by the table 218 listing job groups to be moved forward. That is, the file name of the temporary input file in the first forwarded execution is input001_copy_{—}1 and the file name of the temporary output file in the first forward moving execution is 001_out_copy_{—}1 to 003_out_copy_{—}1. Similarly, the file name of the temporary input file in the n-th forward moving execution is input001_copy_n and the file name of the temporary output file in the n-th forward moving execution is 001_out_copy_n to 003_out_copy_n.

FIG. 24 shows an example in which the first forwarded processing is performed at 14:00. In this case, data input001 between 7:00 and 14:00 is copied and stored in the temporary input file input001_copy_n (n=1). The temporary input file input001_copy_n (n=1) is input into the job jobA-001 and the output file 001_out obtained from the job jobA-001 is stored after being renamed the temporary output file 001_out_copy_n (n=1). Similarly, the temporary output files 002_out_copy_n (n=1), 003_out_copy_n (n=1) are stored. n is, as described above, an additional number (serial number) in accordance with the number of times of forwarded execution.

The temporary input file and the temporary output file are created by procedures (g1) to (g5) described below.

(g1) Determine the job group to be moved forward based on the forward moving priority by referring to the table 217 listing candidates to be moved forward.

(g2) Perform the following procedures (g3) to (g5) by referring to information about jobs corresponding to the procedure (g1) in the table 213 listing forward movable jobs.

(g3) Store input data (input file input001 in the example shown in FIG. 24) of the job net by copying as the temporary input file name (input001_copy_n in the example shown in FIG. 24). At this point, count up the number of times of forwarded execution in the table 218, listing job groups to be moved forward, to show the number of times of forwarded processing today and add the number of times of forwarded execution to the file name as the additional number n.

(g4) Move forward and execute the job net. In this case, jobs to be moved forward are jobs within the forwarded execution range.

(g5) Each time a job is finished, the output file (files 001_out to 003_out in the example shown in FIG. 24) is renamed the temporary output file name (001_out_copy_n to 003_out_copy_n in the example shown in FIG. 24) and stored according to the table 213 listing forward movable jobs. At this point, the additional number n similar to one in the procedure (g3) is added to the file name.

### [1-8-2] Control Such that Batch Operation is Performed Correctly Even if the Batch Operation is Performed a Plurality of Times

In the present embodiment, no processing is performed on processed data that has been processed in the second and subsequent forwarded execution and unprocessed data excluding the processed data from input data is selected for processing such that batch operation is performed correctly even if the batch operation is performed a plurality of times.

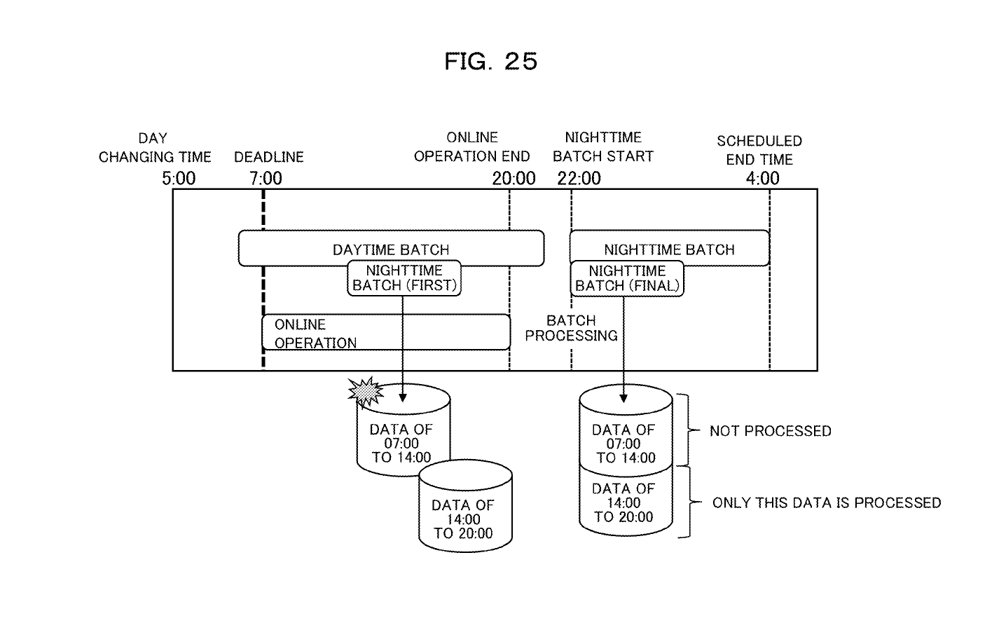

FIG. 25 is a diagram illustrating an example of batch operation when the forwarded processing is performed only once. In the example shown in FIG. 25, data accumulated between 7:00 and 14:00 is processed at 14:00 in the first nighttime batch by being moved forward. Then, in the second (final) nighttime batch started at 22:00, processing on processed data between 7:00 and 14:00 of input data is not performed and instead, processing on unprocessed data (final unprocessed data) accumulated between 14:00 and 20:00 is performed.

On the other hand, data to be processed by a series of jobs (see, for example, the jobs jobA-004, jobA-005 in FIG. 12) after the job that is not executed by being moved forward and thereafter is all data including data processed by forwarded execution. Thus, it is necessary to identify processed data and unprocessed data and to perform merge processing of obtained data in each stage of moving data forward if necessary. Therefore, data obtained by merging data obtained in each stage of moving jobs forward in the final job of forward movable job groups is input into a series of jobs after the job that is not executed by being moved forward and thereafter as input data (see a thick dotted line arrow A from the output file 003_out to the job jobA-004 in FIG. 26).

An example of batch operation when the moving forward processing is performed twice or more will be described with reference to FIG. 26 and procedures (h1) to (h4) described below.

(h1) For n-th (n is an integer equal to 2 or greater) forwarded execution, first make the following preparations before executing a job net. That is, store the input data input001 (all records of resultant DB obtained by online operation) of the job net by copying as the temporary input file input001_copy_n. Then, exclude data processed by forwarded execution from the input data input001 of the job net. More specifically, unprocessed data is obtained by comparing the input data input001 and the temporary input file input001_copy_(n−1) stored during the last forwarded execution is performed and deleting matching data from the input data input001 and input into the job net. In FIG. 26, during the n-th forwarded execution, data between 19:00 and 20:00 (portion not moved forward) is obtained as unprocessed data (final unprocessed data).

(h2) Input the unprocessed data obtained in the procedure (h1) into the first job jobA-001 of the job net as the input file input001 to execute the job net. In this case, the jobs jobA-001 to jobA-003 whose forward movable flag in the table 213 listing forward movable jobs is set to “ON” are executed. Processing of the jobs jobA-004, jobA-005 after the job jobA-003 is performed in the nighttime batch (final).

(h3) Merge output data of the last job jobA-003 (see the output file 003_out on the upper side of FIG. 26; second partial output data) executed in the procedure (h2) with n temporary output files 003_out_copy_{—}1 (first partial output data) to 003_out_copy_n stored during forward execution is performed. Then, store the merge result as the output file 003_out (see the lower side of FIG. 26).

(h4) Input the file for all data (output file 003_out on the lower side of FIG. 26) after merging in the procedure (h3) into the first job jobA-004 (see a thick dotted line arrow A in FIG. 26) of the job group that is not moved forward and executed so that processing by the subsequent jobs jobA-004, jobA-005 is performed.

As shown in FIG. 26, each piece of the output data 00x_out of the job whose forward movable flag is “ON” is merged with the temporary output files 00x_out_copy_{—}1 to 00x_out_copy_n (partial intermediate output data) stored during forward execution is performed and stored. In FIG. 26, x is 1 or 2. After merging, copy files input001_copy_{—}1 to input001_copy_n and 00y_out_copy_{—}1 to 00y_out_copy_n are deleted. In FIG. 26, y is 1, 2, or 3.

### [2] Configuration of the Job Management Server (Processing Apparatus) in the Present Embodiment

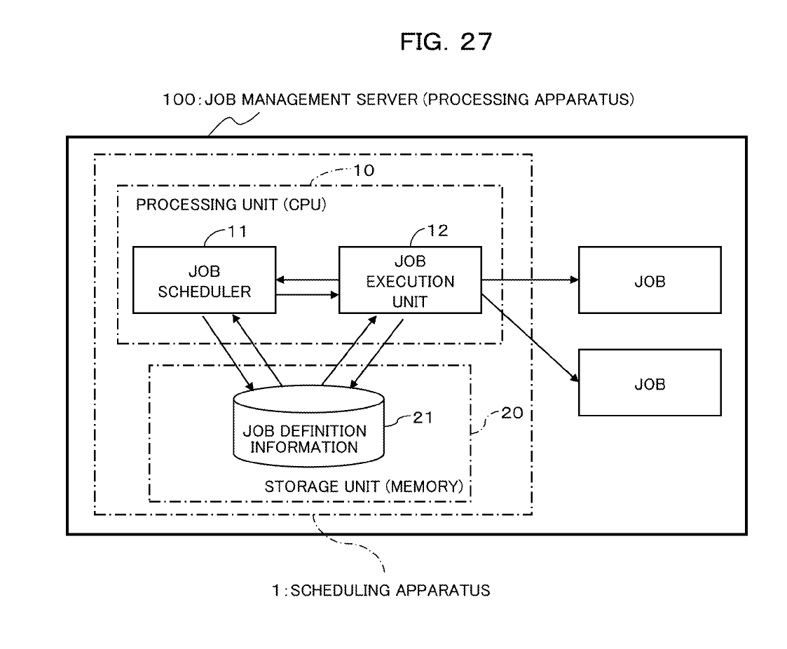

Next, the configuration of a job management server (processing apparatus) 100 in the present embodiment including a scheduling apparatus 1 that performs batch operations by the processing method described in the item [1] will be described with reference to FIG. 27. FIG. 27 is a block diagram showing a hardware configuration example and a function configuration example of the job management server 100 according to the present embodiment.

As shown in FIG. 27, the job management server 100 in the present embodiment is a processing apparatus that performs first operation (online operation) in a first period (online operation period in the daytime) and second operation (batch operation) in a second period (batch operation period in the nighttime) after the first period. The job management server 100 is a computer such as PC (Personal Computer) and functions as the scheduling apparatus 1 described later.

The job management server 100 includes at least a processing unit (processor) 10 such as a CPU (Central Processing Unit) or MPU (Micro-Processing Unit) and a storage unit (memory) 20 such as a RAM (Random Access Memory), an HDD (Hard Disk Drive), and an SSD (Solid State Device).

The processing unit 10 functions as a job scheduler 11 described later by reading and executing a predetermined application program (processing program) from the storage unit 20 and also functions as a job execution unit 12. The predetermined application program is provided in a form recorded in a computer-readable recording medium such as a flexible disk, CD (CD-ROM, CD-R, CD-RW and so on), DVD (DVD-ROM, DVD-RAM, DVD-R, DVD-RW, DVD+R, DVD+RW and so on), and blu-ray disk. In this case, the processing unit 10 reads a program from the recording medium and transfer and stores the program to an internal storage apparatus or an external storage apparatus as a storage unit 20 for use.

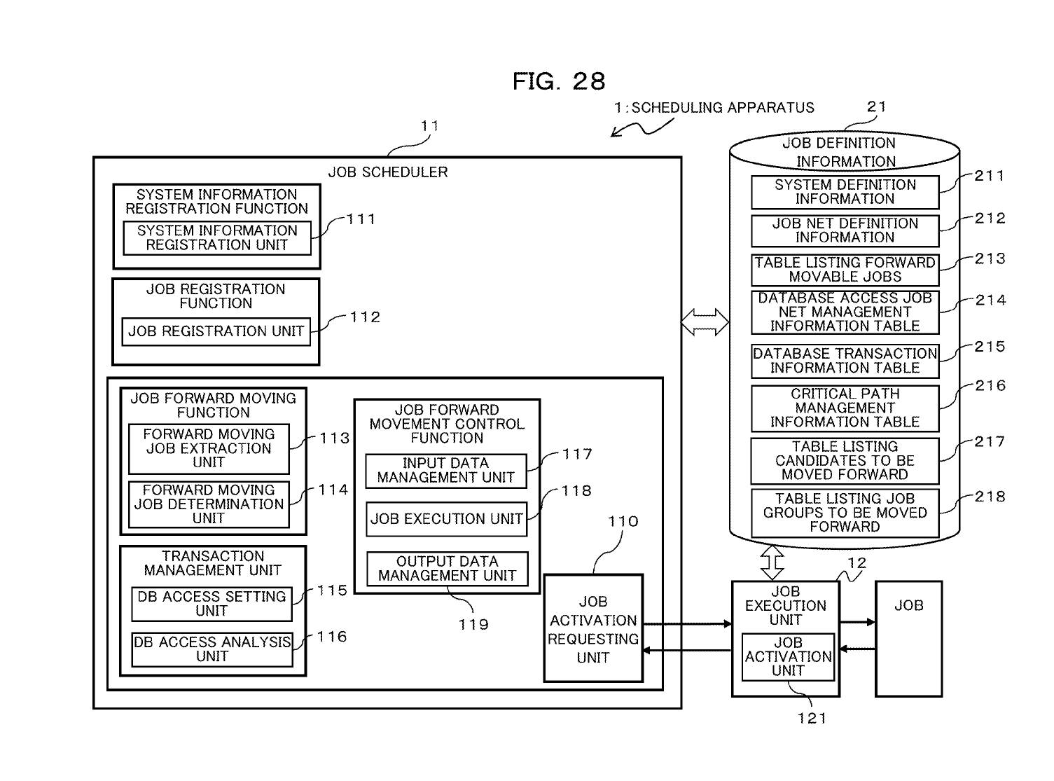

The storage unit 20 stores, in addition to the predetermined application program, various kinds of information needed for processing by the processing unit 10. For example, the storage unit 20 stores job definition information 21 as the various kinds of information. The job definition information 21 contains, as will be described later with reference to FIG. 28, various kinds of information 211 to 218.

In the job management server 100 (scheduling apparatus 1), a job is registered as the job definition information 21.

The job scheduler 11 is used to manage the definition of a job, activation conditions and the like and fulfils the system information registration function, job registration function, job moving forward function, transaction management function, and job forward movement control function, as will be described later with reference to FIG. 28. These functions is realized by, as described above, the predetermined application program (processing program) being read from the storage unit 20 and executed by the processing unit 10.

Further, when activation conditions of a job are satisfied, the job execution unit 12 activates the job in accordance with an activation request of the job from the job scheduler 11. The function as the job execution unit 12 is also realized by the predetermined application program being read by the processing unit 10 from the storage unit 20 and executed.

### [3] Configuration of the Scheduling Apparatus in the Present Embodiment

Next, the configuration of the scheduling apparatus 1 that performs batch operations by the processing method described in the item [1] will be described with reference to FIG. 28. FIG. 28 is a block diagram showing a function configuration example of the scheduling apparatus 1 according to the present embodiment.

As shown in FIG. 28, the scheduling apparatus 1 in the present embodiment includes, as described above with reference to FIG. 27, the job scheduler 11, the job execution unit 12, and the job definition information 21 (storage unit 20).

The job scheduler 11 includes a job activation request unit 110, a system information registration unit 111 that fulfils the system information registration function, and a job registration unit 112 that fulfils the job registration function. The job scheduler 11 also includes a forward moving job extraction unit 113 and a forward moving job determination unit 114 that fulfil the job moving forward function, and a DB access setting unit 115 and a DB access analysis unit 116 that fulfil the transaction management function. Further, the job scheduler 11 includes an input data management unit 117 that fulfils the job forward movement control function, a job execution unit 118, and an output data management unit 119.

The job activation request unit 110 makes a job activation request to a job activation unit 121 of the job execution unit 12 according to instructions from the job execution unit 118 to cause the job activation unit 121 to execute the desired job.

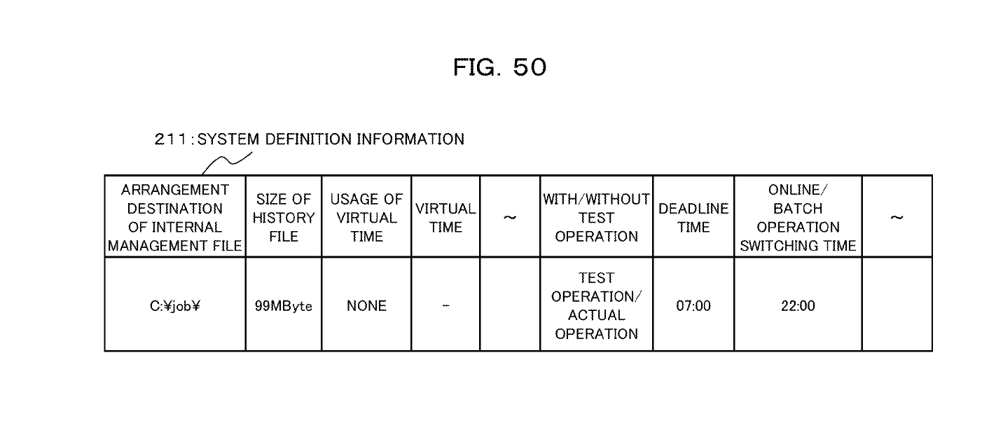

The system information registration unit 111 registers system definition information 211 contained in the job definition information 21 in the storage unit 20 according to instructions of the operator (client), the system administrator or the like. The system definition information 211 includes, as shown in FIG. 50, the arrangement destination of an internal management file, the size of a history file, whether a virtual time is used, the virtual time, whether a test operation is provided, the deadline time, the online/batch operation switching time and the like. FIG. 50 is a diagram showing an example of the system definition information 211 according to the present embodiment.

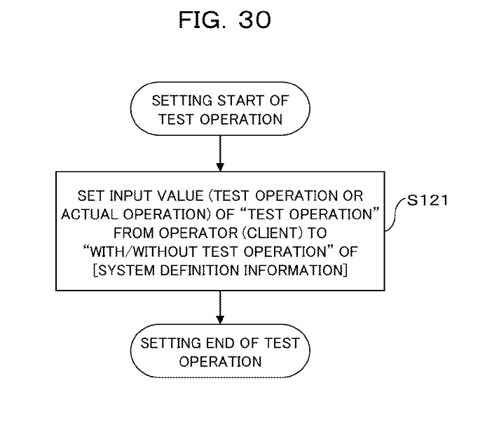

Particularly, whether a test operation is provided, the deadline time, and the online/batch operation switching time are set by, as will be described later with reference to FIGS. 30 to 32 respectively, the operator (client). Whether a test operation is provided is information specifying whether the current operation is a test operation or a full operation (actual operation). The deadline time is, as described above, the start time of the online operation and is a time by which a job net executed in the nighttime needs to be completed (see the above item (c1)). In the example shown in FIG. 50, the time 7:00 is set. The online/batch operation switching time is a time at which the operation is switched from the online operation to the batch operation and in the example shown in FIG. 50, the time 22:00 is set.

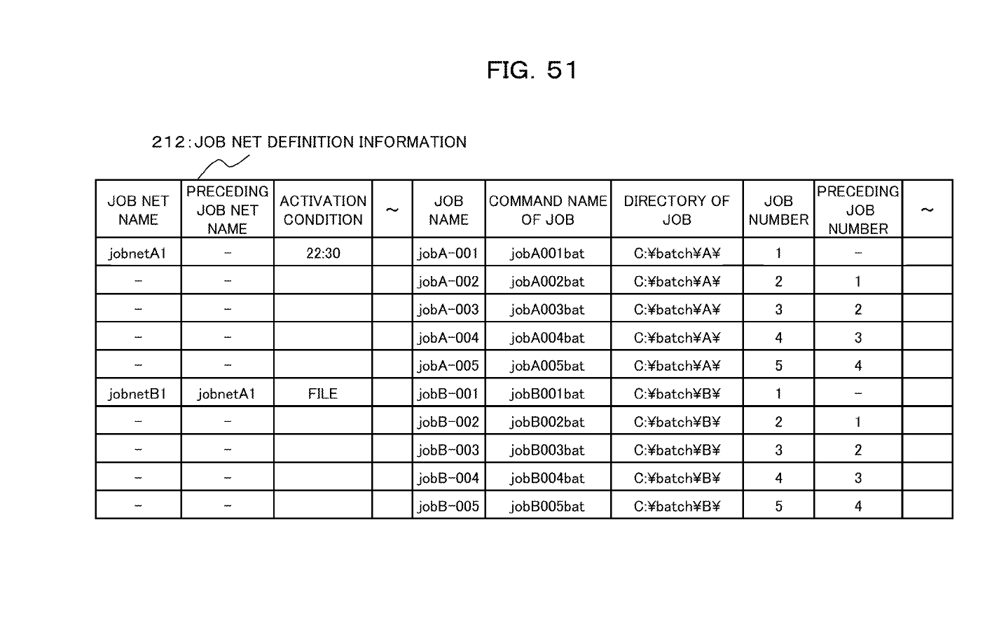

The job registration unit 112 registers job net definition information 212 contained in the job definition information 21 in the storage unit 20 according to instructions of the operator (client), the system administrator or the like. The job net definition information 212 is information defining a job net to be managed by the job management server 100 (scheduling apparatus 1). The job net definition information 212 includes, as shown in FIG. 51, the job net name, preceding job net name, activation conditions such as the activation time of a job net, job name of a job belonging to the job net, command name of each job, directory of each job, job number, and preceding job number. FIG. 51 is a diagram showing an example of the job net definition information 212 according to the present embodiment.

In addition to the system definition information 211 and the job net definition information 212 described above, the table 213 listing forward movable jobs and the database access job net management information table 214 are included in the job definition information 21 of the storage unit 20. Also, the database transaction information table 215, the critical path management information table 216, the table 217 listing candidates to be moved forward, and the table 218 listing job groups to be moved forward are included in the job definition information 21 of the storage unit 20.

The table 213 listing forward movable jobs holds, as shown in, for example, FIG. 13 or 23, information about jobs that can be moved forward and is created as described in the item [1-4-3].

The database access job net management information table 214 holds, as shown in, for example, FIG. 14, 16, 19, or 20, information about a job net accessing each DB and information about the execution time of each job belonging to the job net. More specifically, the table 214 stores, as described in the above item [1-5-1-1], information of the above items (c1) to (c7).

The database transaction information table 215 holds, as shown in, for example, FIG. 15, 17, or 18, information about the transaction amount per unit time with each DB in the processing time zone of a daytime batch. More specifically, the table 215 stores, as described in the above item [1-5-1-2], information of the above items (d1) to (d3).

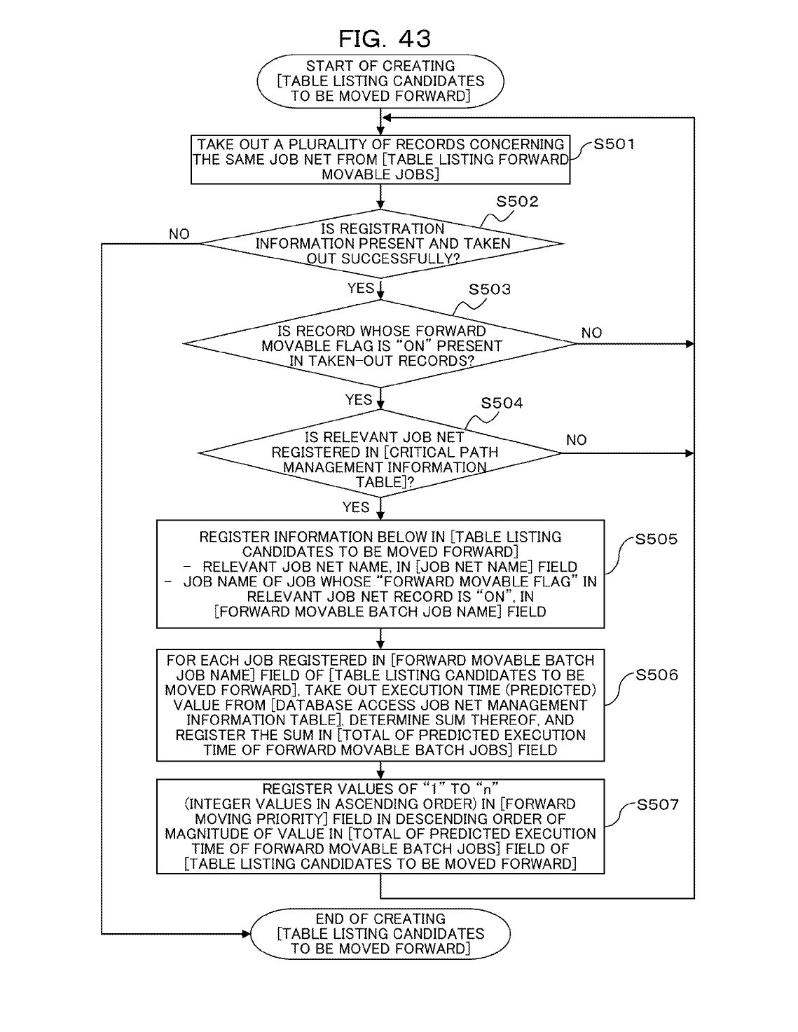

The critical path management information table 216 manages, as described in the above item [1-6-2-2], a critical path calculated based on the predicted execution time of each job in the nighttime recorded in the table 214. As shown in FIG. 52, the job net name of a job net on the critical path is held in the critical path management information table 216. FIG. 52 is a diagram showing an example of the critical path management information table 216 according to the present embodiment. Processing using the critical path management information table 216 will be described later with reference to FIGS. 42 and 43.

The table 217 listing candidates to be moved forward is used, as described in the procedure (e2) of the above item [1-7-1], to extract batch operation in descending order of predicted execution time. In the table 217 listing candidates to be moved forward, as shown in FIG. 21, the job net name, job name of a job belonging to a forward movable job group, the total, and the forward moving priority are associated and stored.

The table 218 listing job groups to be moved forward is used, as described in the procedure (e6) of the above item [1-7-1], to manage job groups determined to be moved forward and executed. In the table 218 listing job groups to be moved forward, as shown in FIG. 22, the job name of a job belonging to a job group to be moved forward, forwarded execution start time, and number of times of forwarded execution (0 in the initial state) are associated and stored.

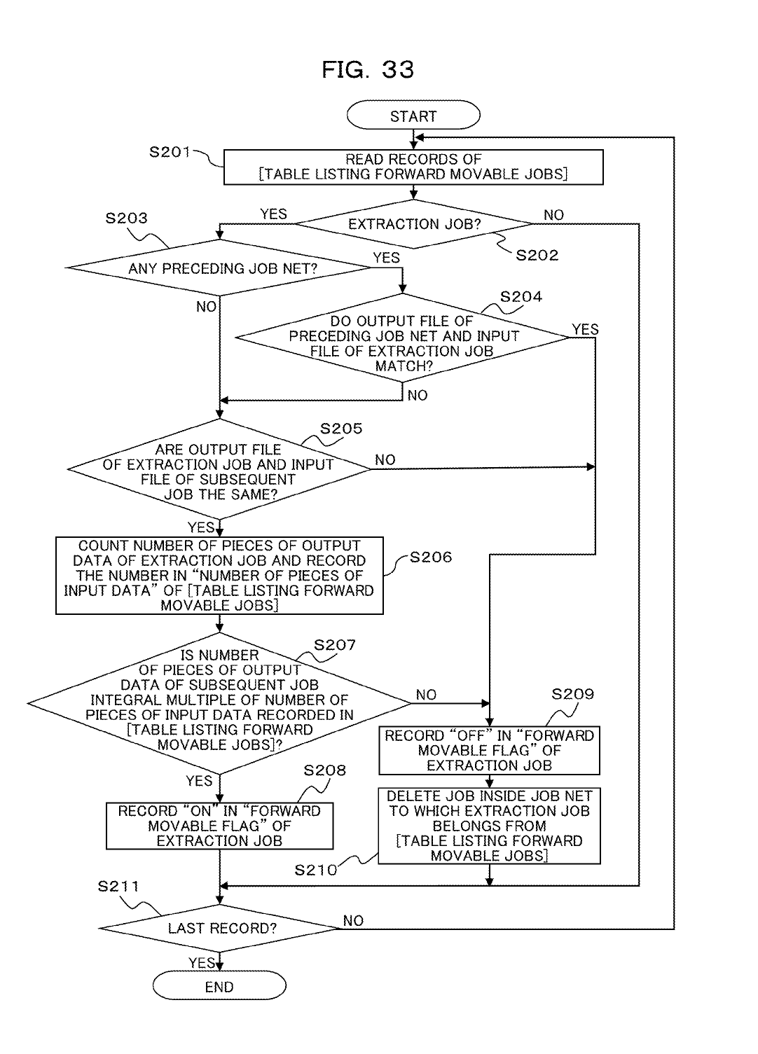

The forward moving job extraction unit 113 analyzes job (application) processing of all jobs during test operation and identifies and records jobs that can be moved forward in the table 213 listing forward movable jobs. Particularly, the forward moving job extraction unit 113 in the present embodiment performs Processing P1 described in the above item [1-4], that is, processing to extract nighttime batches that can be moved forward and executed and the range of forward movable processing (see the processing of the above items [1-4-1] to [1-4-3]). A more concrete operation of the forward moving job extraction unit 113 will be described later with reference to FIGS. 33 to 37.

The forward moving job determination unit 114 is invoked and activated when a longer time (delay) of the nighttime batch of the day is detected by the transaction management function (DB access analysis unit 116 described later). Then, the forward moving job determination unit 114 performs Processing P4 described in the above item [1-7], that is, selection processing (see the processing in the above item [1-7-1]) of nighttime batch operation to be moved forward to the daytime from jobs on the critical path and determination processing (see the processing n the above item [1-7-2]) of the execution start time of the nighttime batch operation. A more concrete operation of the forward moving job determination unit 114 will be described later with reference to FIGS. 43 to 45.

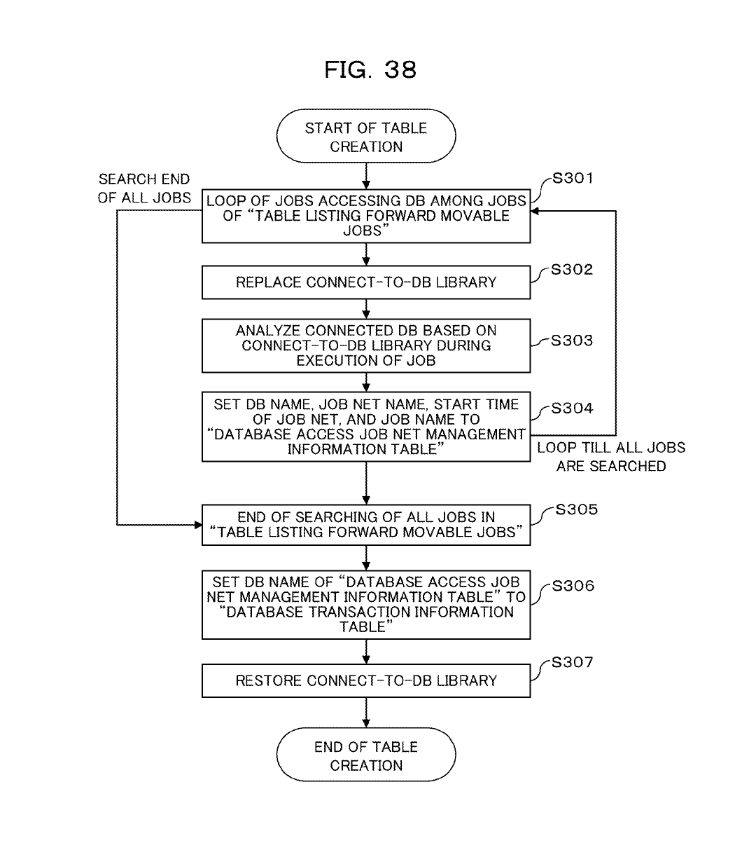

The DB access setting unit 115 performs processing to identify a job accessing DB in a job of nighttime batch operation or online operation during test operation and to acquire information of the transaction amount (normal) with DB being accessed by the job in the online operation. The DB access setting unit 115 also sets the execution time (normal) of a job in a nighttime batch to the database access job net management information table 214. Further, the DB access setting unit 115 performs processing to acquire information of the transaction amount (track record) with DB being accessed by the job in the online operation in a full operation (actual operation). Particularly, the DB access setting unit 115 in the present embodiment performs Processing P2 described in the above item [1-5]. That is, the DB access setting unit 115 investigates DB accessed by a nighttime batch and creates a stable to store the transaction amount (see the processing in the above item [1-5-1]). Also, the DB access setting unit 115 makes a record in the database access job net management information table 214 and the database transaction information table 215 (see the processing in the above item [1-5-2]). A more concrete operation of the DB access setting unit 115 will be described later with reference to FIGS. 38 to 40.

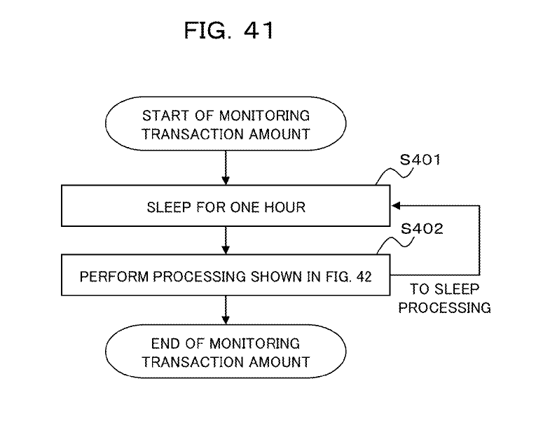

The DB access analysis unit 116 monitors the transaction amount of the job accessing DB acquired by the DB access setting unit 115 in a full operation (actual operation). Then the DB access analysis unit 116 compares the transaction amount during actual operation with that during test operation and, if the transaction amount during actual operation is larger, predicts the execution time of nighttime batch operation. If the nighttime batch operation is determined not to be completed by the deadline time based on the predicted execution time, the DB access analysis unit 116 causes the forward movement control function to move the nighttime batch operation forward. Particularly, the DB access analysis unit 116 in the present embodiment performs monitoring processing of the transaction amount (see the processing in the above item [1-6-1]) and determination processing of necessity of forwarded execution (see the processing in the above item [1-6-2]). A more concrete operation of the DB access analysis unit 116 will be described later with reference to FIGS. 41 and 42.

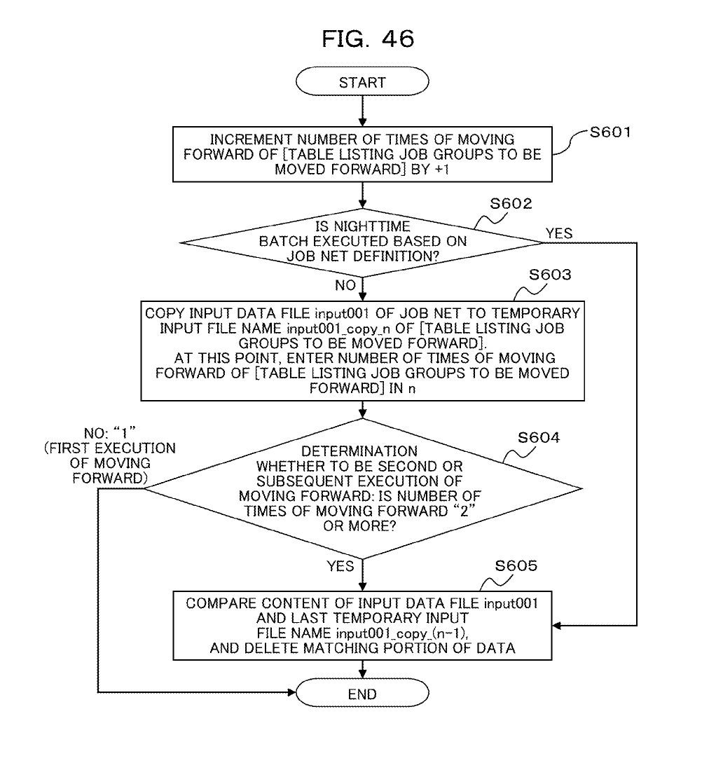

The input data management unit 117 manages only data to be processed (unprocessed data) as input data and performs processing to deliver the data to a job to execute a forward moving job group a plurality of times in the daytime. Particularly, the input data management unit 117 is intended to realize Processing P5 described in the above item [1-8]. A more concrete operation of the input data management unit 117 will be described later with reference to FIG. 46.

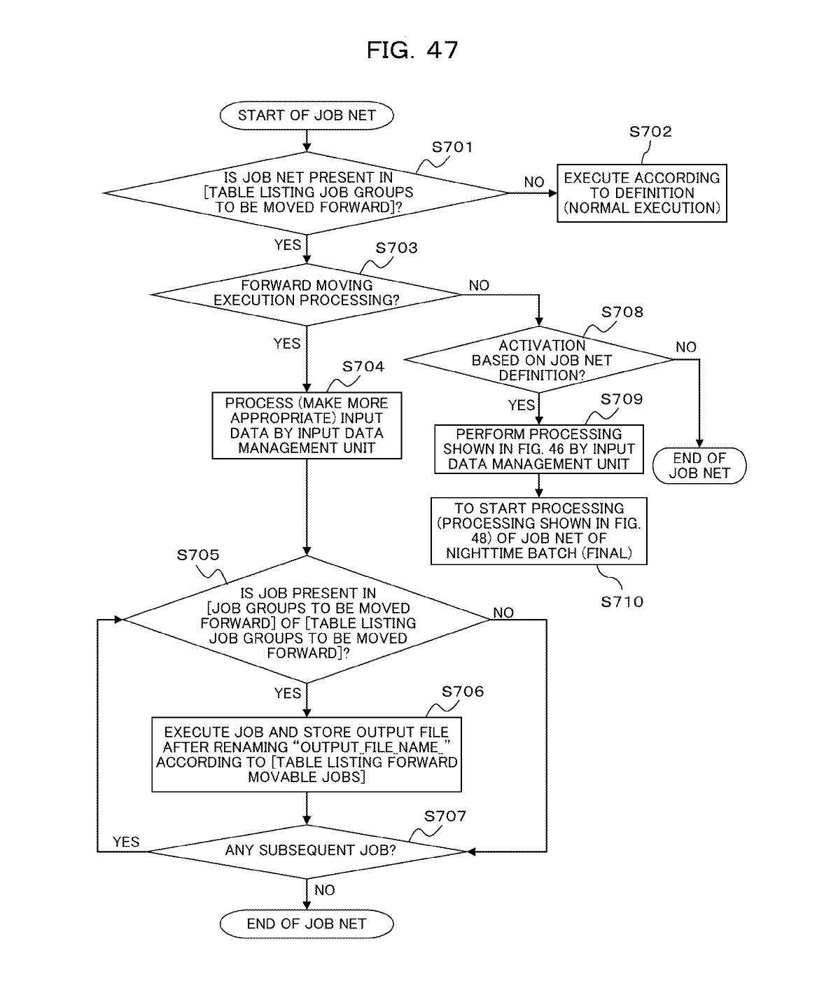

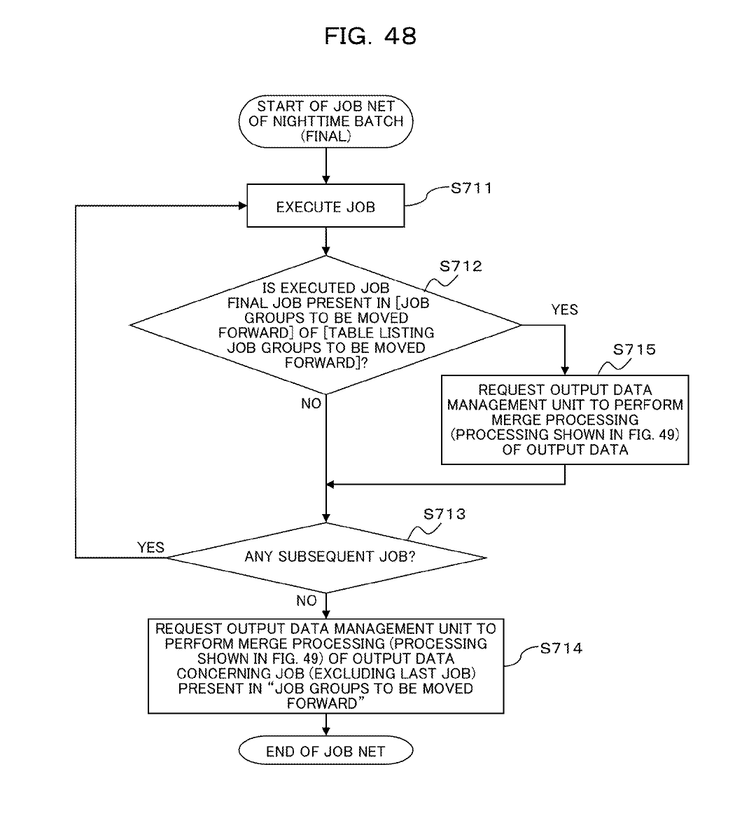

The job execution unit 118 is used to sequentially activate and control jobs within the range of job groups to be moved forward and executed and, when a desired job is activated, issues a job activation request to the job activation unit 121 of the job execution unit 12 via the job activation request unit 110. A more concrete operation of the job execution unit 118 will be described later with reference to FIGS. 47 and 48.

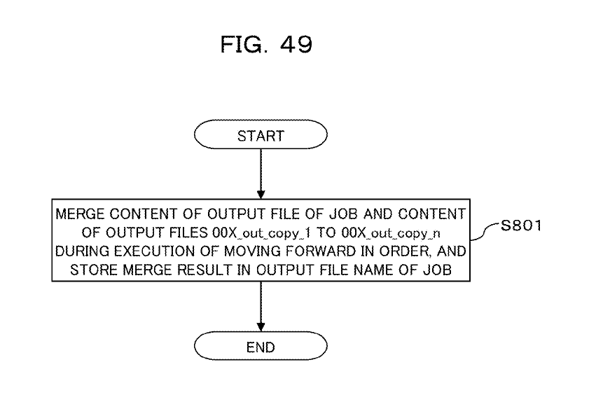

The output data management unit 119 individually manages data output each time job groups are moved forward and executed to execute forward moved job groups a plurality of times and performs merge processing of output data when the final night batch is executed. Particularly, the output data management unit 119 is intended to realize Processing P5 described in the above item [1-8]. A more concrete operation of the output data management unit 119 will be described later with reference to FIG. 49.

The functions as the system information registration unit 111, the job registration unit 112, the forward moving job extraction unit 113, the forward moving job determination unit 114, the DB access setting unit 115, the DB access analysis unit 116, the input data management unit 117, the job execution unit 118, and the output data management unit 119 described above are realized by, as described above, a predetermined application program (processing program) being read from the storage unit 20 and executed by the processing unit 10.

The forward moving job extraction unit 113 in the present embodiment functions as the following extraction unit. The extraction unit extracts a job group (forward movable jobs) including an extraction job that performs data extraction processing and a subsequent job that performs processing on a data segment extracted by the extraction job within the range of the data segment. The extraction unit also extracts a job (processing job/output job) that performs one or a plurality of pieces of processing on one data segment input by a prior job and outputs one or a plurality of pieces of output data as a subsequent job. Further, if a job that performs cooperation processing with another operation is included in the job group, the extraction unit excludes the job group from jobs to be moved forward. If an output job described below is included in the subsequent job, the extraction unit selects jobs from the extraction job to the subsequent job immediately before the output job from the job group as jobs to be moved forward. The output job is an output job that performs message issuing processing, an output job that performs file transfer processing, or an output job whose output triggers the start of another operation (next job).

The forward moving job determination unit 114, the DB access analysis unit 116, and the job execution unit 118 in the present embodiment function as a control unit that moves the extracted job group forward from the batch operation period (second period) to the online operation period (first period) to execute the job group in parallel with the online operation.

The DB access analysis unit 116 in the present embodiment functions as the following analysis unit. The analysis unit sets execution timing to execute a job group in parallel with online operation by moving the job group forward in accordance with processing conditions of the online operation. The analysis unit also performs at least the following processing (1) to (4). The processing (1) monitors the transaction amount of the online operation with DB used by batch operation as processing conditions of the online operation. The processing (2) calculates the predicted execution time of the batch operation based on the transaction amount of the online operation. The processing (3) determines whether the batch operation is completed by a preset completion time (deadline time) based on the predicted execution time of the batch operation. The processing (4) sets the execution timing in accordance with timing in which the batch operation is determined not to be completed by the completion time.

The input data management unit 117 in the present embodiment functions as the following input data management unit. When the job group is executed in the execution timing, the input data management unit inputs unprocessed data excluding processed data by the job group into the job group as data to be processed by the job group. When the online operation period changes to the batch operation period, the input data management unit inputs final unprocessed data excluding processed data by the job group into the job group as final data to be processed by the job group.

The output data management unit 119 in the present embodiment functions as the following output data management unit. The output data management unit merges first partial output data obtained by the job group from unprocessed data and second partial output data obtained by the job group from the final unprocessed data each time the execution timing comes. When the online operation period changes to the batch operation period, the output data management unit merges and outputs partial intermediate output data obtained by each job belonging to the job group as intermediate output data for each job each time the execution timing comes.

The job execution units 118, 12 in the present embodiment function as the following job execution unit. The job execution unit executes jobs after the job group in batch operation on merged output data.

### [4] Operation of the Scheduling Apparatus in the Present Embodiment

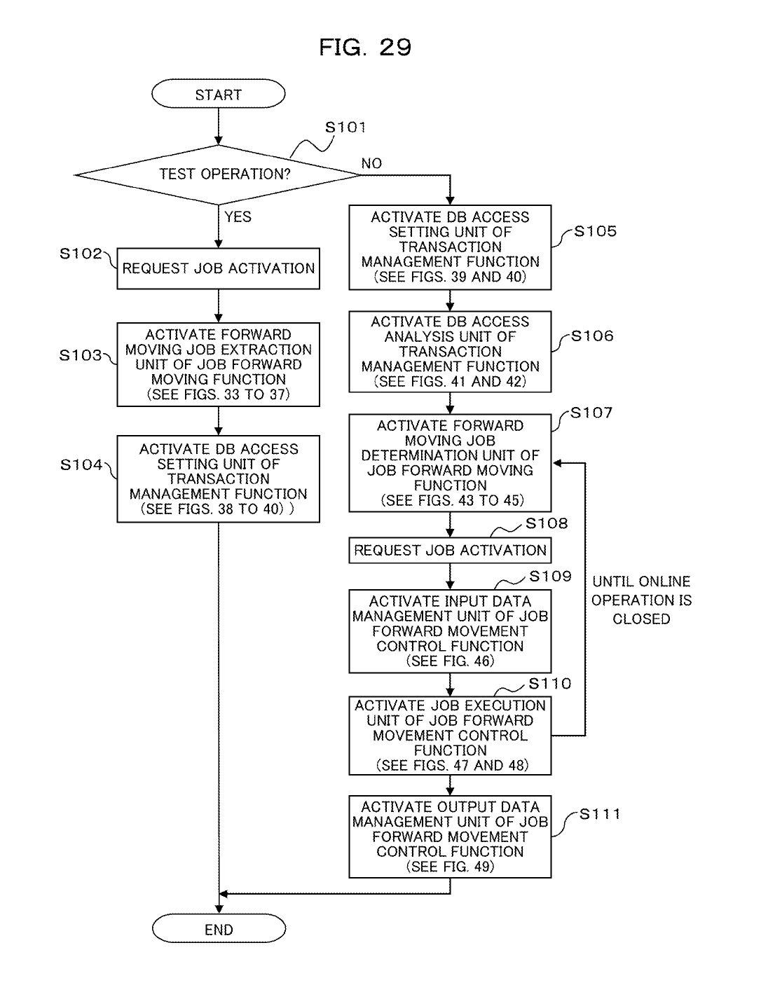

Next, the operation of the scheduling apparatus 1 according to the present embodiment will be described with reference to FIGS. 29 to 49.

### [4-1] Overview of Operation During Job Execution

First, an overview of operation during job execution by the scheduling apparatus 1 according to the present embodiment will be provided according to the flow chart (steps S101 to S111) shown in FIG. 29.

The scheduling apparatus 1 determines whether the operation this time is a test operation (step S101) and, if the operation is a test operation (YES route in step S101), makes a job activation request to the job execution unit 12 via the job activation request unit 110 (step S102). Then, the scheduling apparatus 1 activates the forward moving job extraction unit 113 of the job forward moving function (step S103) and causes the forward moving job extraction unit 113 to perform processing described later with reference to FIGS. 33 to 37. Then, the scheduling apparatus 1 activates the DB access setting unit 115 of the transaction management function (step S104) and causes the DB access setting unit 115 to perform processing described later with reference to FIGS. 38 to 40 before terminating the processing.

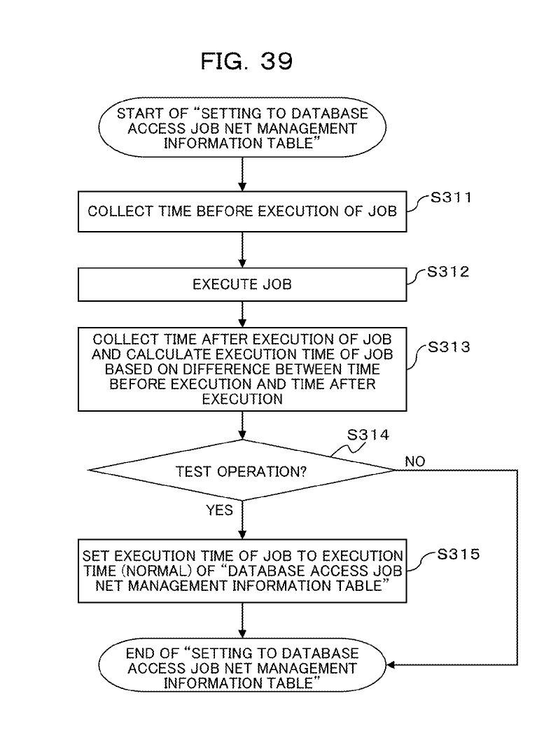

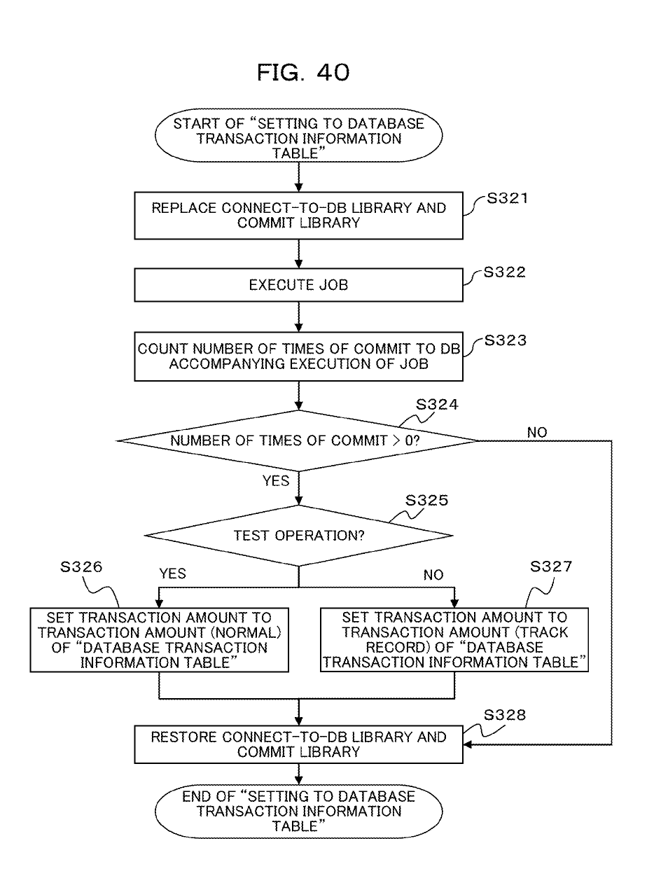

On the other hand, if the operation is not a test operation, that is, is a full operation (actual operation) (NO route in step S101), the scheduling apparatus 1 activates the DB access setting unit 115 of the transaction management function (step S105) and causes the DB access setting unit 115 to perform processing described later with reference to FIGS. 39 and 40. The scheduling apparatus 1 also activates the DB access analysis unit 116 of the transaction management function (step S106) and causes the DB access analysis unit 116 to perform processing described later with reference to FIGS. 41 and 42. Further, the scheduling apparatus 1 activates the forward moving job determination unit 114 of the job forward moving function (step S107) and causes the forward moving job determination unit 114 to perform processing described later with reference to FIGS. 43 to 45. Then, the scheduling apparatus 1 makes a job activation request to the job execution unit 12 via the job activation request unit 110 (step S108).

Thereafter, the scheduling apparatus 1 activates the input data management unit 117 of the job forward movement control function (step S109) and causes the input data management unit 117 to perform processing described later with reference to FIG. 46. The scheduling apparatus 1 also activates the job execution unit 118 of the job forward movement control function (step S110) and causes the job execution unit 118 to perform processing described later with reference to FIGS. 47 and 48.

The above processing of steps S107 to S110 is repeatedly performed until the online operation is closed. When the online operation is closed, the scheduling apparatus 1 activates the output data management unit 119 of the job forward movement control function (step S111) and causes the output data management unit 119 to perform processing described later with reference to FIG. 49 before terminating the processing.

### [4-2] Setting Operation to the Scheduling Apparatus

Next, a test operation setting operation, a deadline time setting operation, and an online/batch operation switching time setting operation in the scheduling apparatus 1 in the present embodiment will be described according to the flow chart (steps S121 to S123) shown in FIGS. 30 to 32.

Before processing being started by the scheduling apparatus 1, the system information registration unit 111 sets, as shown in FIG. 30, whether a test operation is provided according to instructions of the operator (client) or the like to the system definition information 211 of the job definition information 21 (step S121). At this point, an input value (test operation/full operation) of “Test operation” from the operator (client) is set to the field of “With/without test operation” of the system definition information 211 (see FIG. 50). Normally, before the actual operation of a business operation system is started, “Test operation” is set to make preparations and then, “Full operation” is set to start the actual operation.

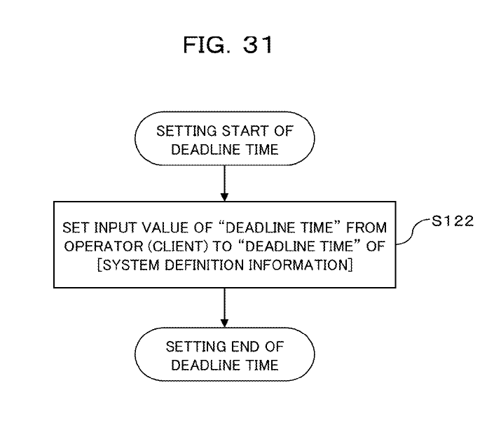

Also before processing being started by the scheduling apparatus 1, the system information registration unit 111 sets, as shown in FIG. 31, the deadline time according to instructions of the operator (client) or the like to the system definition information 211 of the job definition information 21 (step S122). At this point, an input value (for example, the time 7:00) of “Deadline time” from the operator (client) is set to the field of “Deadline time” of the system definition information 211 (see FIG. 50).

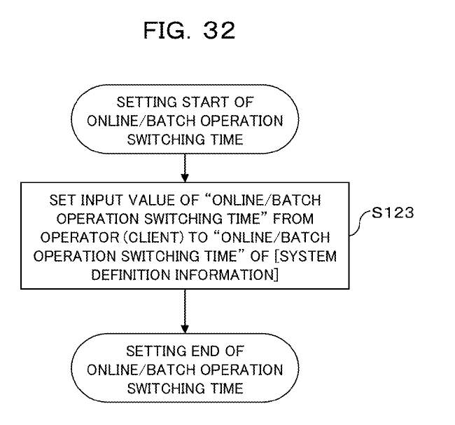

Also before processing being started by the scheduling apparatus 1, the system information registration unit 111 sets, as shown in FIG. 32, the online/batch operation switching time according to instructions of the operator (client) or the like to the system definition information 211 of the job definition information 21 (step S123). At this point, an input value (for example, the time 22:00) of “Online/batch operation switching time” from the operator (client) is set to the field of “Online/batch operation switching time” of the system definition information 211 (see FIG. 50).

### [4-3] Operation of the Forward Moving Job Determination Unit

Next, the operation of the forward moving job extraction unit 113 in the scheduling apparatus 1 in the present embodiment will be described according to the flow chart shown in FIGS. 33 to 37.

### [4-3-1] ON/OFF Setting of the Forward Movable Flag of an Extraction Job

An ON/OFF setting operation of the forward movable flag of an extraction job by the forward moving job extraction unit 113, that is, a determination operation whether the extraction job can be moved forward will be described according to the flow chart (steps S201 to S211) shown in FIG. 33. When the processing in FIG. 33 is started, the fields of the number of pieces of input data, forward movable flag, temporary input file name, and temporary output file name are empty in the table 213, listing forward movable jobs, shown in FIG. 13 and various kinds of information are set to the other fields.

The forward moving job extraction unit 113 first reads records of the table 213 one by one starting with the first record (step S201). Then, the forward moving job extraction unit 113 determines whether the job corresponding to the read record is an extraction job, that is, whether the extraction job flag is “ON” or “OFF” (step S202).

If the corresponding job is not an extraction job, that is, the extraction job flag is “OFF” (NO route in step S202), the forward moving job extraction unit 113 determines whether the read record is the last record (step S211). If the read record is the last record (YES route in step S211), the forward moving job extraction unit 113 terminates the processing and, if the read record is not the last record (NO route in step S211), the forward moving job extraction unit 113 returns to the processing in step S201.

If the corresponding job is an extraction job, that is, the extraction job flag is “ON” (YES route in step S202), the forward moving job extraction unit 113 determines whether there is any preceding job net that inputs a file into the extraction job by referring to the field of the preceding job net name of the relevant record (step S203). If there is a preceding job net (YES route in step S203), the forward moving job extraction unit 113 determines whether an output file of the preceding job net and an input file of the extraction job match (step S204).

If the output file of the preceding job net and the input file of the extraction job match (YES route in step S204), this corresponds to the condition described in the procedure (B1-1) of the above item [1-4-1]. Thus, the forward moving job extraction unit 113 sets “OFF” to the forward movable flag of the extraction job (step S209) and deletes jobs in the job net to which the extraction job belongs from the table 213 listing forward movable jobs (step S210). Then, the forward moving job extraction unit 113 proceeds to processing in step S211.

If there is no preceding job net (NO route in step S203) or the output file of the preceding job net and the input file of the extraction job do not match (NO route in step S204), the forward moving job extraction unit 113 makes the following determination (step S205). That is, the forward moving job extraction unit 113 determines whether an output file of the extraction job and an input file of a subsequent job are the same (see the procedure (B1-3)).

If the output file of the extraction job and the input file of the subsequent job are the same (YES route in step S205), the forward moving job extraction unit 113 counts the number of pieces of output data of the extraction job and records the counted number in the field of the number of pieces of input data of the relevant record (step S206; see the procedure (B1-2)). Then, the forward moving job extraction unit 113 determines whether the number of pieces of output data of the subsequent job is an integral multiple of the number of pieces of input data recorded in the field of the number of pieces of input data (step S207; see the procedure (B1-3)).

If the number of pieces of output data of the subsequent job is an integral multiple of the number of pieces of input data recorded in the field of the number of pieces of input data (YES route in step S207), the forward moving job extraction unit 113 determines that the extraction job is “to be moved forward” and sets “ON” to the forward movable flag of the relevant extraction job (step S208; see the procedure (B1-5)). Then, the forward moving job extraction unit 113 proceeds to processing in step S211.

If the output file of the extraction job and the input file of the subsequent job are different (NO route in step S205) or the number of pieces of output data of the subsequent job is not an integral multiple of the number of pieces of input data recorded in the field of the number of pieces of input data (NO route in step S207), the forward moving job extraction unit 113 performs the processing described below. That is, the forward moving job extraction unit 113 determines that the extraction job is “not to be moved forward” and proceeds to processing in step S209 (see the procedure (B1-4)).

### [4-3-2] ON/OFF Setting of the Forward Movable Flag of Jobs Other than the Extraction Job

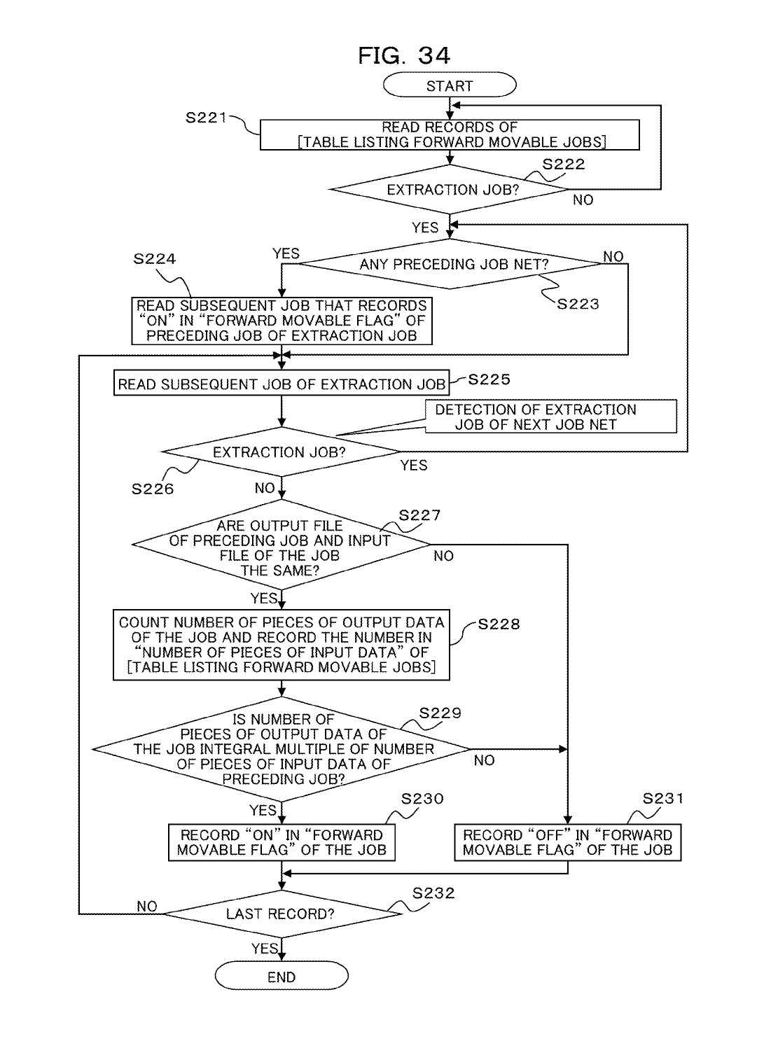

An ON/OFF setting operation of the forward movable flag of jobs other than the extraction job by the forward moving job extraction unit 113, that is, a determination operation whether jobs other than the extraction job can be moved forward will be described according to the flow chart (steps S221 to S232) shown in FIG. 34. It is assumed that the processing shown in FIG. 34 is performed after the processing shown in FIG. 33.

The forward moving job extraction unit 113 first reads records of the table 213, listing forward movable jobs, one by one starting with the first record (step S221). Then, the forward moving job extraction unit 113 determines whether the job corresponding to the read record is an extraction job, that is, whether the extraction job flag is “ON” or “OFF” (step S222).

If the corresponding job is not an extraction job, that is, the extraction job flag is “OFF” (NO route in step S222), the forward moving job extraction unit 113 returns to the processing in step S221. If the corresponding job is an extraction job, that is, the extraction job flag is “ON” (YES route in step S222), the forward moving job extraction unit 113 determines whether there is any preceding job that inputs a file into the job (step S223).

If there is a preceding job (YES route in step S223), the forward moving job extraction unit 113 records “ON” in the forward movable flag of the preceding job of the extraction job (step S224). After “ON” is recorded in the forward movable flag as described above or there is no preceding job (NO route in step S223), the forward moving job extraction unit 113 reads a record of the job subsequent to the extraction job from the table 213 listing forward movable jobs (step S225). Then, the forward moving job extraction unit 113 determines whether the job is an extraction job, that is, whether the extraction job flag of the job is “ON” or “OFF” (step S226). In step S226, an extraction job in the next job net is detected.

If the job is an extraction job, that is, the extraction job flag is “ON” (YES route in step S226), the forward moving job extraction unit 113 returns to the processing in step S223. On the other hand, if the job is not an extraction job, that is, the extraction job flag is “OFF” (NO route in step S226), the forward moving job extraction unit 113 makes the following determination (step S227). That is, the forward moving job extraction unit 113 determines whether an output file of the preceding job and an input file of the job are the same (see the procedure (B1-3)).

If the output file of the preceding job and an input file of the job are the same (YES route in step S227), the forward moving job extraction unit 113 counts the number of pieces of output data of the job and records the counted number in the field of the number of pieces of input data of the job (step S228; see the procedure (B1-2)). Then, the forward moving job extraction unit 113 determines whether the number of pieces of output data of the job is an integral multiple of the number of pieces of input data of the preceding job (step S229; see the procedure (B1-3)).

If the number of pieces of output data of the job is an integral multiple of the number of pieces of input data of the preceding job (YES route in step S229), the forward moving job extraction unit 113 determines that the job is “to be moved forward” and sets “ON” to the forward movable flag of the job (step S230; see the procedure (B1-5)). Then, the forward moving job extraction unit 113 determines whether the read record is the last record (step S232). If the read record is the last record (YES route in step S232), the forward moving job extraction unit 113 terminates the processing and, if the read record is not the last record (NO route in step S232), the forward moving job extraction unit 113 returns to the processing in step S225.

If the output file of the preceding job and the input file of the job are different (NO route in step S227) or the number of pieces of output data of the job is not an integral multiple of the number of pieces of input data of the preceding job (NO route in step S229), the forward moving job extraction unit 113 performs the processing described below. That is, the forward moving job extraction unit 113 determines that the job is “not to be moved forward” and sets “OFF” to the forward movable flag of the extraction job (step S231; see the procedure (B1-4)). Then, the forward moving job extraction unit 113 proceeds to the processing in step S232.

### [4-3-3] Exclusion of Jobs Including Cooperation Processing

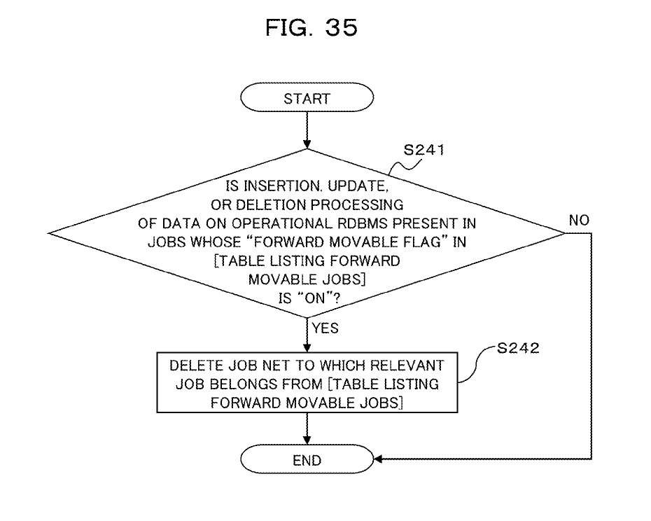

The operation to exclude jobs including cooperation processing from jobs to be moved forward by the forward moving job extraction unit 113 will be described according to the flow chart (steps S241 and S242) shown in FIG. 35.

After the ON/OFF settings of the forward movable flag of jobs are made by the processing shown in FIGS. 33 and 34, the forward moving job extraction unit 113 checks all jobs belonging to a job group determined to be forward movable for cooperation processing with other operations. That is, the forward moving job extraction unit 113 checks jobs whose forward movable flag is “ON” in the table 213 listing forward movable jobs for processing of insert, update, or delete from business RDBMS (Relational DataBase Management System) (step S241).

If relevant processing is found (YES route in step S241), the forward moving job extraction unit 113 deletes the job net (job group) to which the relevant job belongs from the table 213 listing forward movable jobs (step S242). On the other hand, no relevant processing is found (NO route in step S241), the forward moving job extraction unit 113 terminates the exclusion operation of jobs including cooperation processing.

### [4-3-4] Extraction of the Range of Forward Movable Jobs

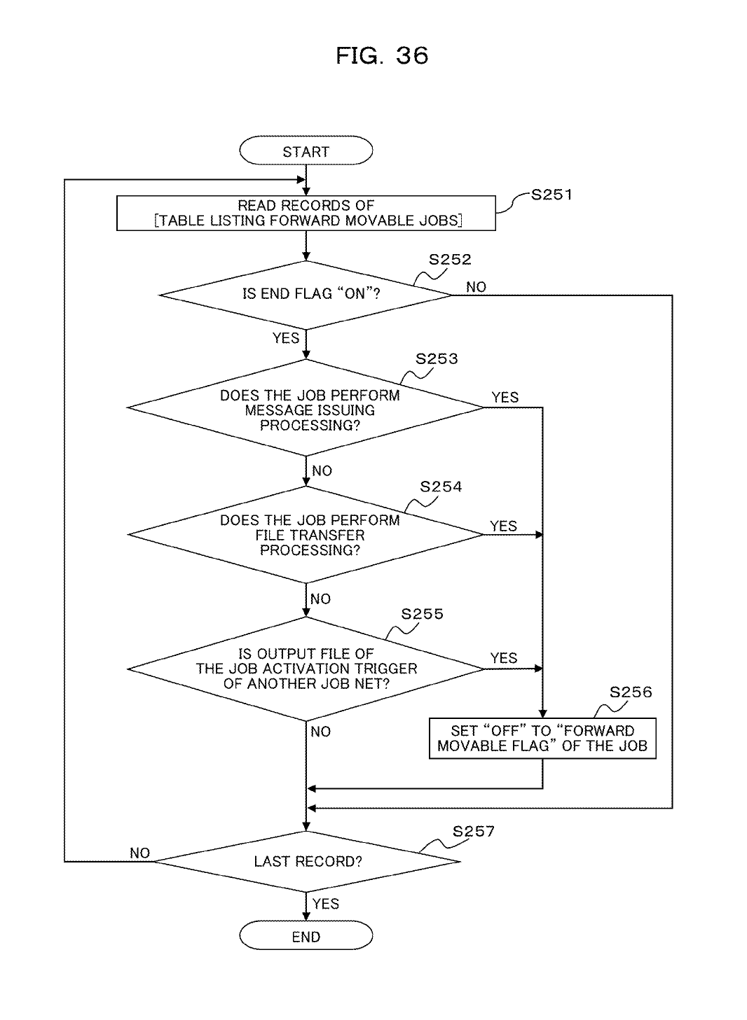

An extraction operation of the range of forward movable jobs by the forward moving job extraction unit 113 will be described according to the flow chart (steps S251 to S257) shown in FIG. 36. After excluding jobs including cooperation processing from jobs to be moved forward by the processing shown in FIG. 35, the forward moving job extraction unit 113 extracts the range of forward movable jobs. That is, the forward moving job extraction unit 113 extracts the range of jobs that can actually be moved forward from a forward movable job group.

The forward moving job extraction unit 113 reads records of the table 213, listing forward movable jobs, one by one starting with the first record (step S251). Then, the forward moving job extraction unit 113 determines whether the job corresponding to the read record is a terminating job, that is, the terminating flag thereof is “ON” (step S252).

If the corresponding job (relevant job) is not a terminating job, that is, the terminating flag is not “ON” (NO route in step S252), the forward moving job extraction unit 113 determines whether the read record is the last record (step S257). If the read record is the last record (YES route in step S257), the forward moving job extraction unit 113 terminates the processing and, if the read record is not the last record (NO route in step S257), the forward moving job extraction unit 113 returns to the processing of step S251.

If the relevant job is a terminating job, that is, the terminating flag is “ON” (YES route in step S252), the forward moving job extraction unit 113 determines whether the job has performed message issuing processing by referring to the job net definition information 212 (see FIG. 51) (step S253). If the job has performed the message issuing processing (YES route in step S253), the forward moving job extraction unit 113 sets “OFF” to the forward movable flag of the job (step S256) before proceeding to processing in step S257.

If the job has not performed the message issuing processing (NO route in step S253), the forward moving job extraction unit 113 determines whether the job has performed file transfer processing by referring to the job net definition information 212 (step S254). If the job has performed the file transfer processing (YES route in step S254), the forward moving job extraction unit 113 sets “OFF” to the forward movable flag of the job (step S256) before proceeding to the processing in step S257.

If the job has not performed the file transfer processing (NO route in step S254), the forward moving job extraction unit 113 determines whether an output file of the job triggers the activation of another job net by referring to the job net definition information 212 (step S255). If an output file of the job triggers the activation of another job net (YES route in step S255), the forward moving job extraction unit 113 sets “OFF” to the forward movable flag of the job (step S256) before proceeding to the processing in step S257. On the other hand, if an output file of the job does not trigger the activation of another job net (NO route in step S255), the forward moving job extraction unit 113 proceeds to processing in step S257.

As described above, the selection of up to which processing (job) of a forward movable job group is forward movable, that is, the extraction of the range of actually forward movable jobs from a forward movable job group is performed by the forward moving job extraction unit 113.

### [4-3-5] Settings of the Temporary Input File Name and the Temporary Output File Name

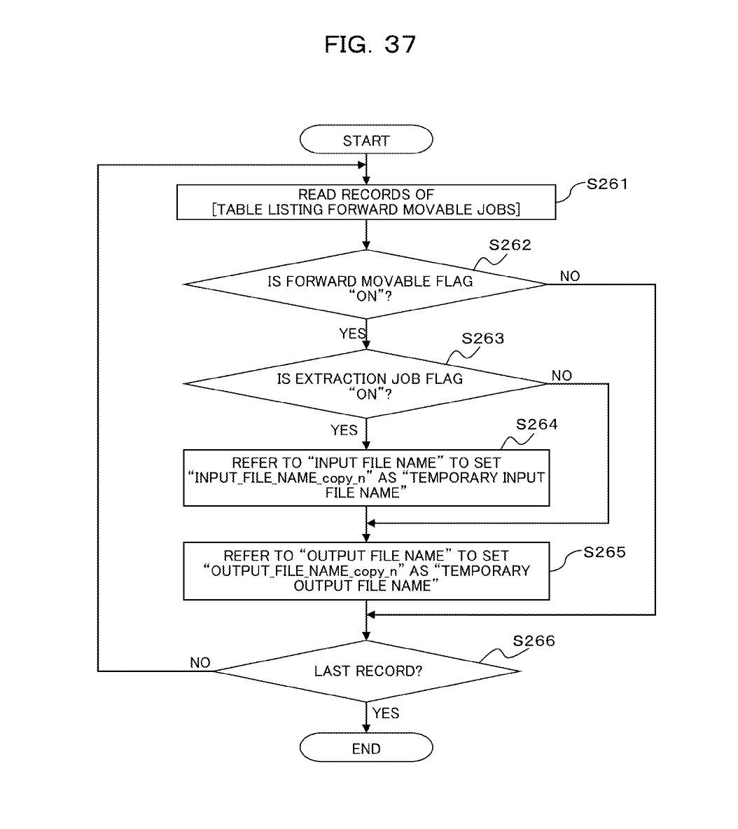

A setting operation of the temporary input file name and the temporary output file name by the forward moving job extraction unit 113 will be described according to the flow chart (steps S261 to S266) shown in FIG. 37.

After performing the processing shown in FIGS. 33 to 36, the forward moving job extraction unit 113 reads records of the table 213, listing forward movable jobs, one by one starting with the first record (step S261). Then, the forward moving job extraction unit 113 determines whether the forward movable flag of the read record is “ON” (step S262).

If the forward movable flag is “OFF” (NO route in step S262), the forward moving job extraction unit 113 determines whether the read record is the last record (step S266). If the read record is the last record (YES route in step S266), the forward moving job extraction unit 113 terminates the processing and, if the read record is not the last record (NO route in step S266), the forward moving job extraction unit 113 returns to the processing of step S261.

If the forward movable flag is “ON” (YES route in step S262), the forward moving job extraction unit 113 determines whether the extraction job flag of the read record is “ON” (step S263). If the extraction job flag is “ON” (YES route in step S263), the forward moving job extraction unit 113 sets “input_file_name_copy_n” to the field of the temporary input file name by referring to the input file name of the record (step S264). For example, for the record of the job jobA-001 in the table 213, listing forward movable jobs, shown in FIG. 13, “input001” is set as the input file name and “input001_copy_n” is set as the temporary input file name.

After the temporary input file name being set or if the extraction job flag is “OFF” (NO route in step S263), the forward moving job extraction unit 113 sets “output_file_name_copy_n” to the field of the temporary output file name by referring to the output file name of the record (step S265). For example, for the record of the job jobA-001 in the table 213, listing forward movable jobs, shown in FIG. 13, “001_out” is set as the output file name and “001_out_copy_n” is set as the temporary output file name. Thereafter, the forward moving job extraction unit 113 proceeds to processing in step S266.

### [4-4] Operation of the Database Access Setting Unit

Next, the operation of the DB access setting unit 115 in the scheduling apparatus 1 according to the present embodiment will be described according to the flow chart shown in FIGS. 38 to 40.

### [4-4-1] Investigation of DB Accessed by the Nighttime Batch and Creation of a Table Storing the Transaction Amount (See the Processing in the Above Item [1-5-1])

An investigation operation of DB accessed by the nighttime batch and a creation operation of a table storing the transaction amount by the DB access setting unit 115 will be described according to the flow chart (steps S301 to S307) shown in FIG. 38.

The DB access setting unit 115 causes processing of steps S302 to S304 to loop for jobs that, among jobs of the table 213 listing forward movable jobs, access DB (step S301). The DB access setting unit 115 replaces a CONNECT-TO-DB library (step S302) and analyzes the connected DB based on the CONNECT-TO-DB library during execution of a job (step S303). Then, based on the analysis result, the DB access setting unit 115 sets the DB name, job net name, start time of each job net, and job name to the database access job net management information table 214 (step S304; see FIG. 14).

The DB access setting unit 115 repeatedly performs the processing of steps S301 to S304 until all jobs are searched and, when the search of all jobs is completed (step S305), performs the processing described below. That is, the DB access setting unit 115 sets the DB name of the database access job net management information table 214 to the database transaction information table 215 (step S306; see FIG. 15). Then, the DB access setting unit 115 restores the CONNECT-TO-DB library (step S307) before terminating the processing.

### [4-4-2] Recording in the Database Access Job Net Management Information Table (See the Processing in the Above Item [1-5-2])

A setting (recording) operation in the database access job net management information table 214 by the DB access setting unit 115 will be described according to the flow chart (steps S311 to S315) shown in FIG. 39.

After collecting the time before executing a job (step S311), the DB access setting unit 115 causes the job execution unit 12 to execute the job (step S312). Then, the DB access setting unit 115 collects the time after executing the job and calculates the execution time of the job based on a difference between the time before the execution and the time after the execution (step S313).

Then, the DB access setting unit 115 determines whether the current operation is a test operation (step S314). If the current operation is a test operation (YES route in step S314), the DB access setting unit 115 sets the calculated execution time to the field of the execution time (normal) corresponding to the executed job in the database access job net management information table 214 (step S315; see FIG. 16) and then terminates the processing. On the other hand, if the current operation is not a test operation, that is, a full operation (NO route in step S314), the DB access setting unit 115 terminates the processing.

### [4-4-3] Recording in the Database Transaction Information Table (See the Processing in the Above Item [1-5-2])

A setting (recording) operation in the database transaction information table 215 by the DB access setting unit 115 will be described according to the flow chart (steps S321 to S328) shown in FIG. 40.

The DB access setting unit 115 replaces a CONNECT-TO-DB library and COMMIT library (step S321) and causes the job execution unit 12 to execute a job (step S322). Then, the DB access setting unit 115 counts the number of times of COMMIT to DB accompanying the execution of the job (step S323).

Then, the DB access setting unit 115 determines whether the counted number of times of COMMIT to DB is larger than 0 (step S324). If the number of times of COMMIT is 0, that is, DB is not accessed (NO route in step S324), the DB access setting unit 115 restores the CONNECT-TO-DB library and COMMIT library (step S328) before terminating the processing.

If the number of times of COMMIT is larger than 0, that is, DB is accessed (YES route in step S324), the DB access setting unit 115 determines whether the current operation is a test operation (step S325). If the current operation is a test operation (YES route in step S325), the DB access setting unit 115 sets the transaction amount per unit time based on the number of times of COMMIT to the field of the transaction amount (normal) of the database transaction information table 215 (step S326; see FIG. 17). Then, the DB access setting unit 115 proceeds to processing in step S328.

On the other hand, if the current operation is not a test operation, that is, the current operation is a full operation (NO route in step S325), the DB access setting unit 115 sets the transaction amount per unit time based on the number of times of COMMIT to the field of the transaction amount (track record) of the database transaction information table 215 (step S327; see FIG. 18). Then, the DB access setting unit 115 proceeds to the processing in step S328.

### [4-5] Operation of the DB Access Analysis Unit

Next, the operation of the DB access analysis unit 116 in the scheduling apparatus 1 in the present embodiment will be described according to the flow chart shown in FIGS. 41 and 42.

When the DB access analysis unit 116 starts to monitor the transaction amount with the start of the online operation in a full operation of the business operation system, the DB access analysis unit 116 performs processing shown in FIG. 42 (monitoring of the transaction amount and the determination of necessity of forwarded execution) every hour, for example. That is, as shown in FIG. 41, the DB access analysis unit 116 performs the processing shown in FIG. 42 every hour by repeating sleep processing of one hour (step S401) and the processing shown in FIG. 42 (step S402). When the online operation end time comes, the DB access analysis unit 116 terminates the monitoring of the transaction amount.

A monitoring operation of the transaction amount (see the processing in the above item [1-6-1]) and a determination operation of necessity of forwarded execution (see the processing in the above item [1-6-2]) by the DB access analysis unit 116 will be described according to the flow chart (steps S411 to S417) shown in FIG. 42.

The DB access analysis unit 116 monitors the transaction amount (track record) every hour based on the transaction amount (track record) obtained in step S327 (DB access setting unit 115) in FIG. 40 involved in the full operation (step S411). Then, the DB access analysis unit 116 performs processing in steps S412 to S417 every hour based on the transaction amount (track record).

That is, the DB access analysis unit 116 determines whether the transaction amount (track record) of the job net to which the target job belongs is larger than the transaction amount (normal) in the database transaction information table 215 (step S412).

If the transaction amount (track record) is equal to or less than the transaction amount (normal)(NO route in step S412), the DB access analysis unit 116 updates the database access job net management information table 214 of the target job such that the value of the execution time (normal) is set as the value of the execution time (predicted) (step S416; see the above item [1-6-2-1] and FIG. 19). Then, the DB access analysis unit 116 terminates the processing and performs the sleep processing for one hour.

On the other hand, if the transaction amount (track record) is larger than the transaction amount (normal)(YES route in step S412), the DB access analysis unit 116 updates the database access job net management information table 214 of the target job such that the value calculated in the item [1-6-2-2] according to the above Formula (1) is set as the value of the execution time (predicted) (step S413; see the above item [1-6-2-2] and FIG. 20).

Then, the DB access analysis unit 116 re-evaluates the critical path up to the deadline time based on the predicted execution time of each job. In addition, the DB access analysis unit 116 sets, as shown in FIG. 52, job net names of job nets present on the re-evaluated critical path to the critical path management information table 216 (step S414).

Then, the DB access analysis unit 116 determines whether the predicted end time calculated based on the sum of predicted execution times of all jobs in the job nets on the critical path exceeds the deadline time (step S415). If the predicted end time does not exceed the deadline time (NO route in step S415), the DB access analysis unit 116 terminates the processing and performs the sleep processing for one hour.

If the predicted end time exceeds the deadline time (YES route in step S415), the DB access analysis unit 116 causes the forward moving job determination unit 114 to perform the processing in FIGS. 43 to 45 (step S417) and then terminates the processing and performs the sleep processing for one hour.

### [4-6] Operation of the Forward Moving Job Determination Unit

Next, the operation of the forward moving job determination unit 114 in the scheduling apparatus 1 in the present embodiment will be described according to the flow chart shown in FIGS. 43 to 45.

### [4-6-1] Selection of Nighttime Batch Operation to be Moved Forward to the Daytime (See the Processing of the Above Item [1-7-1])

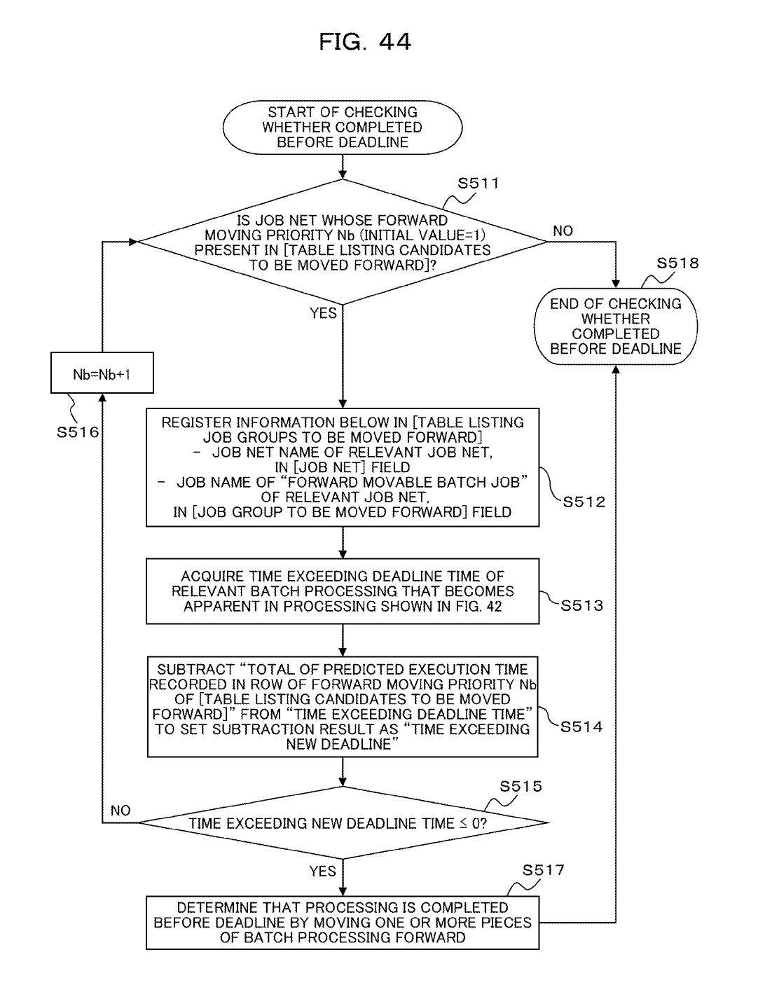

A selection operation of nighttime batch operation to be moved forward to the daytime by the forward moving job determination unit 114 will be described according to the flow chart (steps S501 to S507) shown in FIG. 43 and the flow chart (steps S511 to S518) shown in FIG. 44.

The forward moving job determination unit 114 first starts, as shown in FIG. 43, creation processing (see the procedure (e1) and the procedure (e2) in the above item [1-7-1]) of the table 217 listing candidates to be moved forward. That is, the forward moving job determination unit 114 fetches a plurality of records concerning the same job net from the table 213 listing forward movable jobs (step S501). The forward moving job determination unit 114 determines whether registration information (record) is present and records are successfully fetched (step S502). If records are successfully fetched (YES route in step S502), the forward moving job determination unit 114 determines whether, among fetched records, any record whose forward movable flag is “ON” is present (step S503).

If a record whose forward movable flag is “ON” is present (YES route in step S503), the forward moving job determination unit 114 determines whether the relevant job net is registered in the critical path management information table 216 (see FIG. 52) (step S504). If the relevant job net is registered in the critical path management information table 216 (YES route in step S504), the forward moving job determination unit 114 registers the following information in the table 217 listing candidates to be moved forward (step S505). That is, the job net name of the relevant job net is registered in the [job net name] field of the table 217 listing candidates to be moved forward. Also, the job name of a job whose forward movable flag in the relevant job net record is “ON” is registered in the [forward movable batch job name] field of the table 217 listing candidates to be moved forward.

The forward moving job determination unit 114 fetches the value of the execution time (predicted) from the database access job net management information table 214 for each job registered in the [forward movable batch job name] field of the table 217 listing candidates to be moved forward. Then, the forward moving job determination unit 114 calculates the total of the fetched execution time (predicted) of each job and registers the total in the [total of predicted execution times of forward movable batch jobs] field of the table 217 listing candidates to be moved forward (step S506; see FIG. 21).

Further, the forward moving job determination unit 114 registers the value “1” to “n” (integer value in ascending order) indicating the priority in the [total of predicted execution times of forward movable batch jobs] field of the table 217 listing candidates to be moved forward (step S507; see FIG. 21).

After the priority being registered, if no record whose forward movable flag is “ON” is present (NO route in step S503) or the relevant job net is registered in the critical path management information table 216 (NO route in step S504), the forward moving job determination unit 114 returns to the processing in step S501.

If fetching of records fails (NO route in step S502), the forward moving job determination unit 114 terminates the creation processing of the table 217 listing candidates to be moved forward. At this point, if the table 217 listing candidates to be moved forward is not created, the forward moving job determination unit 114 terminates the processing. On the other hand, if the table 217 listing candidates to be moved forward is created, the forward moving job determination unit 114 starts processing shown in FIG. 44, that is, “check processing whether batch operation is completed by the deadline time” (see the procedures (e3) to (e7) in the above item [1-7-1]).

When the check processing is started, as shown in FIG. 44, the forward moving job determination unit 114 determines whether a job net of the forward moving priority Nb (1 as the initial value) is present in the table 217 listing candidates to be moved forward (step S511). If a job net of the forward moving priority Nb is present (YES route in step S511), the forward moving job determination unit 114 registers the following information in the table 218 listing job groups to be moved forward (step S512). That is, the job net name of the relevant job net is registered in the [job net name] field of the table 218 listing job groups to be moved forward. Also, the job name of “forward movable batch job” of the relevant job net is registered in the [job group to be moved forward] field of the table 218 listing job groups to be moved forward.

Then, the forward moving job determination unit 114 acquires a “time exceeding the deadline time” that becomes apparent in the processing shown in FIG. 42 (step S513). The forward moving job determination unit 114 subtracts “total of predicted execution times entered in records (rows) of the forward moving priority Nb in the table 217 listing candidates to be moved forward” from the acquired “time exceeding the deadline time”. The forward moving job determination unit 114 sets the subtraction result as the new “time exceeding the deadline time” (step S514).

Then, the forward moving job determination unit 114 determines whether the new “time exceeding the deadline time” is equal to 0 or less (step S515). If the new “time exceeding the deadline time” is equal to 0 or less (YES route in step S515), the forward moving job determination unit 114 determines that the processing is completed by the deadline time by moving one or a plurality of pieces of batch operation forward (step S517). If it is determined that the processing is completed by the deadline time, the forward moving job determination unit 114 terminates the “check processing” (step S518).

On the other hand, if the new “time exceeding the deadline time” is larger than 0 (NO route in step S515), the forward moving job determination unit 114 determines that the processing is not completed by the deadline time. Then, the forward moving job determination unit 114 adds 1 to the forward moving priority Nb (step S516) and repeatedly performs the processing in step S511 and thereafter.

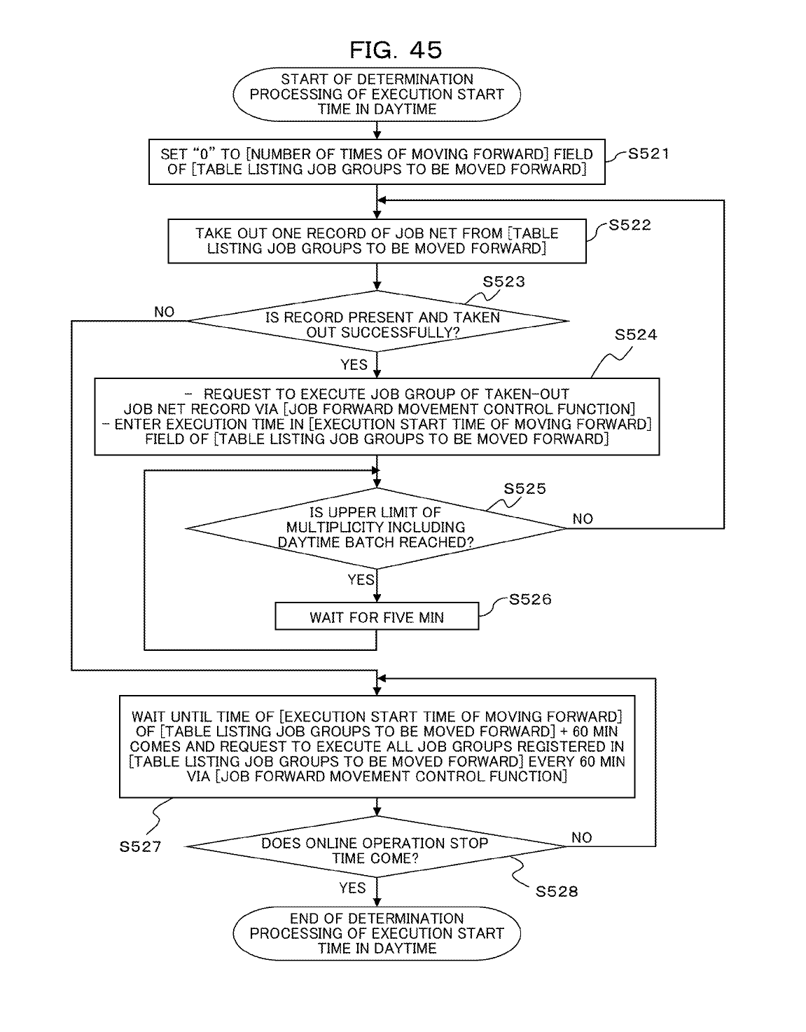

If no job net of the forward moving priority Nb is present (NO route in step S511), the forward moving job determination unit 114 terminates the “check processing” (step S518). When terminating the “check processing” in step S518, the forward moving job determination unit 114 performs one of the following processing. That is, when it is determined that the processing is completed by the deadline time, the forward moving job determination unit 114 starts the processing shown in FIG. 45, that is, “determination processing of the execution start time in the daytime”. Otherwise, the forward moving job determination unit 114 notifies the system administrator or the like of an alarm to prevent forwarded execution.

### [4-6-2] Determination of the Execution Start Time of Nighttime Batch Operation in the Daytime (See the Processing in the Above Item [1-7-2])

A determination operation of the execution start time of nighttime batch operation in the daytime (see the procedures (f1) to (f4) in the above item [1-7-2]) by the forward moving job determination unit 114 will be described according to the flow chart (steps S521 to S528) shown in FIG. 45.

The forward moving job determination unit 114 sets “0” to the [number of times of forwarded execution] field of the table 218 listing job groups to be moved forward (step S521). Then, the forward moving job determination unit 114 fetches records of a job net one by one starting with the first record from the table 218 listing job groups to be moved forward (step S522). The forward moving job determination unit 114 determines whether any record is present and records are successfully fetched (step S523).

If records are successfully fetched (YES route in step S523), the forward moving job determination unit 114 performs the following processing. That is, the forward moving job determination unit 114 issues an execution request of a job group of fetched job net records to the job execution unit 12 via the job forward movement control function (see FIG. 28) and the job activation request unit 110. Also, the forward moving job determination unit 114 enters the execution time in the [forwarded execution start time] field of the table 218 listing job groups to be moved forward (step S524).

Then, the forward moving job determination unit 114 determines whether processing multiplicity of the processing currently being performed reaches the upper limit including daytime batches (step S525). If the processing multiplicity reaches the upper limit (YES route in step S525), the forward moving job determination unit 114 waits for five min (step S526) and then returns to the processing in step S525. Batch operation is thereby inhibited from being performed and the inhibited batch operation is started to be performed when a vacancy of processing multiplicity arises. On the other hand, if the processing multiplicity does not reach the upper limit (NO route in step S525), the forward moving job determination unit 114 returns to the processing in step S522.

If fetching of records fails (NO route in step S523), the forward moving job determination unit 114 performs the following processing. That is, the forward moving job determination unit 114 waits until the time of the forwarded execution start time of the table 218+60 min. Then, the forward moving job determination unit 114 issues an execution request of all job groups registered in the table 218, listing job groups to be moved forward, to the job execution unit 12 via the job forward movement control function (see FIG. 28) and the job activation request unit 110 every 60 min (step S527). At this point, the forward moving job determination unit 114 exercises control such that an execution request is not made by exceeding the upper limit of the processing multiplicity including daytime batches by processing similar to processing in step S525 or S526.

Then, the forward moving job determination unit 114 determines whether the online operation stop time has come (step S528). If the online operation stop time has not yet come (NO route in step S528), the forward moving job determination unit 114 returns to the processing in step S527. On the other hand, if the online operation stop time has come (YES route in step S528), the forward moving job determination unit 114 terminates the “determination processing of the execution start time in the daytime”.

### [4-7] Operation of the Input Data Management Unit (See the Processing of the Above Item [1-8])

Next, the operation of the input data management unit 117 (see particularly the procedure (h1) and the procedure (h2) in the above item [1-8-2]) in the scheduling apparatus 1 in the present embodiment will be described according to the flow chart (steps S601 to S605) shown in FIG. 46.

When the forwarded execution start time of the table 218 listing job groups to be moved forward comes, the job net of the relevant job group to be moved forward is activated. Immediately after the job net is activated, the input data management unit 117 is activated to process input data. First, the input data management unit 117 adds 1 to the number of times of forwarded execution of the table 218 listing job groups to be moved forward (step S601).

Then, the input data management unit 117 determines whether job execution this time is nighttime batch execution based on the job net definition, that is, whether the job group to be executed is executed as a nighttime batch (final) (step S602). If the job execution is not nighttime batch execution based on the job net definition (NO route in step S602), the input data management unit 117 performs the following processing. That is, the input data management unit 117 copies the input data file input001 of the job net as the temporary input file of the temporary input file name input001_copy_n of the table 213 listing forward movable jobs. At this point, the number of times of forwarded execution of the table 218 listing job groups to be moved forward is entered as the value of “n” (step S603).

Then, the input data management unit 117 determines whether the execution of this forwarded execution is the second or subsequent forwarded execution, that is, whether the number of times of forwarded execution of the table 218 listing job groups to be moved forward is 2 or greater (step S604). If the number of times of forwarded execution is 1, that is, this forwarded execution is the first forwarded execution (NO route in step S604), the input data management unit 117 terminates the processing.

If the number of times of forwarded execution is 2 or more (YES route in step S604), the input data management unit 117 performs the following processing. That is, the input data management unit 117 compares data content of the input file data input001 and that of the temporary input file input001_copy_(n−1) stored during the last forwarded execution and deletes a matching data portion from the input data input001 (step S605). Accordingly, unprocessed data is obtained and input into the job net. Then, the input data management unit 117 terminates the processing.

If the job execution this time is nighttime batch execution based on the job net definition, that is, the job group to be executed is executed as a nighttime batch (final) (YES route in step S602), the input data management unit 117 proceeds to the processing in step S605.

### [4-8] Operation of the Job Execution Unit

Next, the operation of the job execution unit 118 in the scheduling apparatus 1 in the present embodiment will be described according to the flow chart (steps S701 to S710) shown in FIG. 47 and the flow chart (steps S711 to S715) shown in FIG. 48.

The job execution unit 118 is activated accompanying the start of execution of a job net and first determines whether the started job net is included in the table 218 listing job groups to be moved forward (step S701). If the started job net is not included in the table 218 listing job groups to be moved forward (NO route in step S701), the job execution unit 118 is executed according to the job net definition information 212 (see FIG. 51) (step S702; normal execution).

If the started job net is included in the table 218 listing job groups to be moved forward (YES route in step S701), the job execution unit 118 determines whether the job net execution this time is forwarded execution processing (step S703). At this point, the job execution unit 118 compares the forwarded execution start time of the table 218 listing job groups to be moved forward and the online/batch switching time of the system definition information 211 to determine whether the forwarded execution start time is earlier than the switching time.

If the forwarded execution start time is earlier than the switching time, the job execution unit 118 determines that the job net execution this time is forwarded execution processing (YES route in step S703) and input data is processed (made to be appropriate) by the input data management unit 117 (step S704; see step S605 in FIG. 46).

Then, the job execution unit 118 determines whether a job to be executed is included in job groups to be moved forward in the table 218 listing job groups to be moved forward (step S705). If the job to be executed is included in job groups to be moved forward (YES route in step S705), the job execution unit 118 performs the following processing. That is, the job execution unit 118 executes the job and renames the output file obtained by executing the job “output_file_name_copy_n” (n is the number of times of forwarded execution) according to the table 213, listing forward movable jobs, for storage (step S706).

Then, the job execution unit 118 determines whether there is a subsequent job (step S707) and, if there is a subsequent job (YES route in step S707), returns to the processing in step S705. If the job to be executed is not included in job groups to be moved forward (NO route in step S705), the job execution unit 118 proceeds to the processing in step S707. If there is no subsequent job (NO route in step S707), the job execution unit 118 terminates the processing.

On the other hand, if the forwarded execution start time is later than the switching time, the job execution unit 118 determines that the job net execution this time is not forwarded execution processing (NO route in step S703) and determines whether job execution this time is activation based on the job net definition (step S708). If the job execution this time is not activation based on the job net definition (NO route in step S708), the job execution unit 118 terminates the processing.

If the job execution this time is activation based on the job net definition (YES route in step S708), the processing shown in FIG. 46 (see step S605) is performed by the input data management unit 117 (step S709). Then, the job execution unit 118 performs start processing (processing shown in FIG. 48) of the job net of the nighttime batch (final) (step S710).

When the start processing of the job net of the nighttime batch (final) is started, as shown in FIG. 48, the job execution unit 118 executes a job (step S711). Then, the job execution unit 118 determines whether the executed job is the last job in job groups to be moved forward in the table 218 listing job groups to be moved forward (step S712). If the executed job is not the last job in job groups to be moved forward in the table 218 listing job groups to be moved forward (NO route in step S712), the job execution unit 118 determines whether there is a job subsequent to the executed job (step S713).

If there is a subsequent job (YES route of step S713), the job execution unit 118 returns to the processing of step S711 to execute the subsequent job. On the other hand, if there is no subsequent job (NO route of step S713), the job execution unit 118 performs the following processing. That is, the job execution unit 118 requests the output data management unit 119 to perform merge processing (processing shown in FIG. 49) of output data for jobs (excluding the last job) in job groups to be moved forward (step S714) before terminating the processing.

If the executed job is the last job in job groups to be moved forward in the table 218 listing job groups to be moved forward (YES route in step S712), the job execution unit 118 performs the following processing. That is, the job execution unit 118 requests the output data management unit 119 to perform merge processing (processing shown in FIG. 49) of output data (step S715) before proceeding to step S713.

### [4-9] Operation of the Output Data Management Unit (See the Processing in the Above Item [1-8])

The operation of the output data management unit 119 (see particularly the procedure (h3) and the procedure (h4) in the above item [1-8-2]) in the scheduling apparatus 1 in the present embodiment will be described according to the flow chart (step S801) shown in FIG. 49. Output data of job groups executed after being moved forward is stored in a file each time processing is performed by moving jobs forward and therefore, the processing performed by the output data management unit 119 is processing that merges files produced each time processing is performed by moving jobs forward into one output file.

As shown in FIG. 49, the output data management unit 119 merges content of the output file of the job with content of output files 00X_out_copy_{—}1 to 00X_out_copy_n during forwarded execution and stores merged content under the output file name of the job (step S801).

### [5] Effects of the Present Embodiment

When a nighttime batch is moved forward to a time zone of the online operation in the daytime and executed, processing content of a batch operation application itself cannot be grasped according to the current technology and thus, a batch job group that can be moved forward and executed after being divided cannot be identified. Therefore, it is unavoidable to define forward movable batch job groups by hand.

In addition, performing online operation and batch operation in parallel in a time zone of the online operation means that batch operation performed once in the nighttime in the past is performed a plurality of times after being divided into a plurality of pieces. Normally, an application developed for nighttime batch assumes a state in which all data is ready for batch operation (processed at a time) and so the application as a resource of the operator (client) needs to be modified to be able to divide the nighttime batch and execute the divided batches a plurality of times.

According to the present embodiment, by contrast, a method of automatically extracting job groups by allowing batch operation to be moved forward to the daytime and executed after being divided is established. That is, a job group that can be moved forward can be identified from the correlation between the number of pieces of input data and the number of pieces of output data of each job that performs data processing. In this case, whether other batch operation is affected is determined based on operation DB update conditions or message issuing/file transfer conditions in each piece of processing in the job group and thereby, jobs or job groups that is forbidden from being moved forward to the daytime are identified. Accordingly, job groups that may be moved forward can automatically be extracted.

Also according to the present embodiment, even if batch operation is divided into a plurality of pieces and executed a plurality of times without modifying a nighttime batch application specified such that batch operation be performed by assuming a state in which all data for the day is ready, a method of causing no problem such as double processing of the same data or data inconsistency is established. That is, in the first forwarded execution to the n-th forwarded execution (final execution), a difference between the latest data accumulated at each point and data during last execution is extracted and only data of the range to be processed is input into the application (job) to reliably avoid double processing of the same data. Further, data output in the first forwarded execution to the n-th forwarded execution (final execution) is stored while sequentiality being maintained and the same result (output data) as that when batch operation is performed on all data in the nighttime can be obtained by merging all data in the end.

In the present embodiment, therefore, by automatically moving nighttime batch operation forward in the daytime and dividing and executing the batch operation in parallel with online operation, the delay of the nighttime batch operation is substantially reduced and deadline passing is reliably inhibited. That is, the nighttime batch operation can reliably be completed by the start (deadline) of the online operation. Particularly, even under the current circumstances in which the execution time of online operations becomes longer, the execution time of batch operations becomes shorter, and an abrupt increase of data amount beyond expectation can occur, the delay of batch operations is inhibited and deadline passing is inhibited by performing batch operations in parallel with online operations.

According to the present embodiment, as has been described in detail above, when a delay is detected during online operations, a grace period till the deadline is reliably be increased by moving forward and executing batch operations in parallel with online operations so that deadline passing of batch operations can reliably be prevented. In addition, by moving batch operations forward automatically, instead of using manpower (hand), costs are significantly reduced when compared with the reconfiguration and maintenance of schedule by hand and also degradation of operation quality of operations due to human errors can be prevented.

### [6] Others

A preferred embodiment of the invention has been described in detail above, but the present invention is not limited to such a specific embodiment and can be carried out by making various modifications or alterations without deviating from the spirit of the invention.

According to the present embodiment, second operation can be completed by the start of first operation.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a processing program that causes a computer to execute a process comprising:
extracting a job group including an extraction job and a subsequent job from a plurality of scheduled jobs, the plurality of scheduled jobs being included in a second operation, the second operation being scheduled in a second period which is after a first period in which a first operation is scheduled, the extraction job extracting a data group and being included in the plurality of scheduled jobs, and the subsequent job processing on the data group within a range of the data group; and
executing jobs in the extracted job group in the first period.

2. The non-transitory computer-readable recording medium according to claim 1, wherein the process further comprises extracting a job, which performs one piece of the processing or more on the one data group or more input from a prior job and outputs one output data group or more, as the subsequent job.

3. The non-transitory computer-readable recording medium according to claim 1, wherein the process further comprises excluding, when a job that performs cooperation processing with another operation is included in the job group, the job group from target jobs to be executed in the first period.

4. The non-transitory computer-readable recording medium according to claim 1, wherein the process further comprises selecting, when an output job that performs message issuing processing, an output job that performs file transfer processing, or an output job whose output triggers a start of another operation is included in the subsequent job, jobs from the extraction job to the subsequent job immediately before the output job in the job group, as target jobs to be executed in the first period.

5. The non-transitory computer-readable recording medium according to claim 1, wherein the process further comprises setting execution timing for executing the jobs in the first period in accordance with processing conditions of the first operation.

6. The non-transitory computer-readable recording medium according to claim 5, wherein the process further comprises:
monitoring a transaction amount of the first operation on a database used by the second operation as the processing conditions of the first operation;
calculating a predicted execution time of the second operation based on the transaction amount of the first operation;
determining whether the second operation is completed by a preset completion time based on the predicted execution time of the second operation; and
setting the execution timing in accordance with timing in which the second operation is determined not to be completed by the completion time.

7. The non-transitory computer-readable recording medium according to claim 5, wherein the process further comprises inputting, when the jobs are executed in the execution timing, unprocessed data excluding data processed by the job group into the job group as the data to be processed by the job group.

8. The non-transitory computer-readable recording medium according to claim 7, wherein the process further comprises:
when a transition from the first period to the second period takes place, inputting final unprocessed data excluding the data processed by the job group into the job group as the data to be finally processed by the job group;
merging, as output data, first partial output data obtained from the unprocessed data by the job group each time the execution timing comes and second partial output data obtained from the final unprocessed data by the job group; and
executing a job subsequent to the job group in the second processing on the merged output data.

9. The non-transitory computer-readable recording medium according to claim 8, wherein the process further comprises merging and outputting, when the transition from the first period to the second period takes place, partial intermediate output data obtained by each job belonging to the job group each time the execution timing comes, as intermediate output data for each of the jobs.

10. The non-transitory computer-readable recording medium according to claim 1, wherein the first operation is online operation and the second operation is batch operation.

11. The non-transitory computer-readable recording medium according to claim 1, wherein the process further comprises executing the jobs in the extracted job group in parallel with the first operation by moving forward the job group from the second period to the first period.

12. A processing apparatus comprising: an extraction unit that extracts a job group including an extraction job and a subsequent job from a plurality of scheduled jobs, the plurality of scheduled jobs being included in a second operation, the second operation being scheduled in a second period which is after a first period in which a first operation is scheduled, the extraction job extracting a data group and being included in the plurality of scheduled jobs, and the subsequent job processing on the data group within a range of the data group; and
a control unit that executes jobs in the extracted job group in the first period.

13. The processing apparatus according to claim 12, wherein the extraction unit extracts a job, which performs one piece of the processing or more on the one data group or more input from a prior job and outputs one output data group or more, as the subsequent job.

14. The processing apparatus according to claim 12, wherein when a job that performs cooperation processing with another operation is included in the job group, the extraction unit excludes the job group from target jobs to be executed in the first period.

15. The processing apparatus according to claim 12, wherein when an output job that performs message issuing processing, an output job that performs file transfer processing, or an output job whose output triggers a start of another operation is included in the subsequent job, the extraction unit selects jobs from the extraction job to the subsequent job immediately before the output job in the job group, as target jobs to be executed in the first period.

16. The processing apparatus according to claim 12, further comprising: an analysis unit that sets execution timing for executing the jobs in the first period in accordance with processing conditions of the first operation.

17. The processing apparatus according to claim 16, wherein the analysis unit
monitors a transaction amount of the first operation with a database used by the second operation as the processing conditions of the first operation,
calculates a predicted execution time of the second operation based on the transaction amount of the first operation,
determines whether the second operation is completed by a preset completion time based on the predicted execution time of the second operation, and
sets the execution timing in accordance with timing in which the second operation is determined not to be completed by the completion time.

18. The processing apparatus according to claim 16, further comprising: an input data management unit that, when the jobs are executed in the execution timing, inputs unprocessed data excluding data processed by the job group into the job group as the data to be processed by the job group.

19. The processing apparatus according to claim 18, wherein, when a transition from the first period to the second period takes place, the input data management unit inputs final unprocessed data excluding the data processed by the job group into the job group as the data to be finally processed by the job group, further comprising:
an output data management unit that merges, as output data, first partial output data obtained from the unprocessed data by the job group each time the execution timing comes and second partial output data obtained from the final unprocessed data by the job group; and
a job execution unit that executes a job subsequent to the job group in the second processing on the merged output data.

20. A processing method causing a computer to perform processing comprising:
extracting a job group including an extraction job and a subsequent job from a plurality of scheduled jobs, the plurality of scheduled jobs being included in a second operation, the second operation being scheduled in a second period which is after a first period in which a first operation is scheduled, the extraction job extracting a data group and being included in the plurality of scheduled jobs, and the subsequent job processing on the data group within a range of the data group; and
executing jobs in the extracted job group in the first period.
